(19) United States
(12) Patent Application Publication
(10) Pub. No.: US 2002/0171503 A1
(43) Pub. Date: Nov. 21, 2002

(54) Polarized wave separating structure, radio wave receiving converter and antenna apparatus

(76) Inventors: Tetsuyuki Ohtani, Ikoma-shi (JP); Atsushi Nagano, Osaka-shi (JP)

Correspondence Address: NIXON & VANDERHYE P.C., 8th Floor, 1100 North Glebe Road, Arlington, VA, 22201-4714, US

(21) Appl. No.: 10/146,413

(22) Filed: May 16, 2002

(30) Foreign Application Priority Data
May 17, 2001 (JP) 2001-147167(P)
Nov. 15, 2001 (JP) 2001-350117(P)

(51) Int. Cl. H04B 3/04

(52) U.S. Cl. 333/20

(57) ABSTRACT

The septum is extended through the opening to the radio wave receiving portion to separate respective polarized waves received by a pair of radio wave receiving portions, and a space between the septum and the radio wave receiving portion is set such that an end surface of the waveguide on the side of the substrate is surely in contact with a grounding surface provided on one surface of the substrate, and an end surface of the radio wave reflecting portion on the side of the substrate is surely in contact with the grounding surface provided on the other surface of the substrate.

### BACKGROUND OF THE INVENTION

1. Field of the Invention

The present invention relates to a polarized wave separating structure, a radio wave receiving converter (LNB, Low Noise Blockdown Converter) receiving radio wave from a broadcasting satellite, a communication satellite or the like, and to an antenna apparatus.

2. Description of the Background Art

Microwaves used in satellite broadcasting generally include two components. As a representative, for example, circularly polarized waves include dextrorotatory polarized wave (hereinafter referred to as d-polarized wave) and a levorotatory polarized wave (hereinafter referred to as d-polarized wave).

Therefore, a receiving converter receiving radio waves from satellite broadcasting employs a polarized wave separating structure for separating these two components. Particularly when one of the two components (for example, d-polarized wave only) is to be received, higher degree of separation (degree of cross polarization discrimination) is attained by separating the components by the polarized wave separating structure and absorbing the other component (cross polarization component).

A first prior art example of the polarized wave separating structure of the receiving converter will be described with reference to FIG. 43, which is an exploded perspective view of the main part schematically representing the structure, and FIG. 44, which is a cross sectional view taken along the line XXXXIV-XXXXIV of FIG. 43.

On one side of a substrate 103 having a pair of radio wave receiving probes 104a and 104b, a waveguide 101 is arranged. In waveguide 101, there is formed a stepped waveguide septum 101a parting the inside of waveguide 101 into two. On the other side of substrate 103, a radio wave reflecting portion 102 is arranged. In the radio wave reflecting portion 102, there is formed a radio wave reflecting portion septum 102f parting the inside of radio wave reflecting portion 102 into two. On an end surface of radio wave reflecting portion 102 positioned opposite to substrate 103, a radio wave reflecting surface 102a is formed.

On that side of substrate 103 on which radio wave reflecting portion 102 is positioned, a grounding surface (pattern) 105 is provided, along and in contact with end surfaces of radio wave reflecting portion 102 and radio wave reflecting portion septum 102f. On that surface of substrate 103 on which wave guide 101 is positioned, a grounding surface (pattern, not shown) is formed along and in contact with end surfaces of wave guide 101 and wave guide septum 101a.

Grounding surface 105 in contact with radio wave reflecting portion 102 and the grounding surface in contact with waveguide 101 are electrically connected by means of through holes 106. Thus, waveguide 101 and radio wave reflecting portion 102 are kept, by means of the substrate 103, at the ground potential.

The pair of radio wave receiving probes 104a and 104b are formed on that side of substrate 103 on which radio wave reflecting portion 102 is formed. Wiring portions of radio wave receiving probes 104a and 10b are electrically insulated from grounding surface 105, radio wave reflecting portion 102 and waveguide 101.

By waveguide septum 101a and radio wave reflecting portion septum 102f, the inside of waveguide 101 and the inside of radio wave reflecting portion 102 are parted into two waveguide spaces. The circularly polarized wave entering waveguide 101 is separated by the stepped waveguide septum 101a to linearly polarized wave components, and guided to respective waveguide spaces.

In the first prior art example, in order to prevent leakage of radio wave inside waveguide 101 or radio wave reflecting portion 102 to the outside, or to reduce noise, end surfaces of septums 101a and 102f and of waveguide 101 and radio wave reflecting portion 102 are brought into contact with the grounding surfaces of substrate 103.

Now, waveguide 101 including septum 101a and radio wave reflecting portion 102 including septum 102f are formed by casting technique using, for example, aluminum die cast. Considering dimensional accuracy at the time of actual mass production, it is difficult to bring the end surfaces of septums 101a and 102f and of waveguide 101 and radio wave reflecting portion 102 surely into contact with the grounding surfaces of substrate 103.

More specifically, in the first prior art example, when the end surface of radio wave reflecting portion septum 102a is to be surely brought into contact with grounding surface 105 of substrate 103, it follows that the end surface of waveguide 101 cannot surely be brought into contact with the grounding surface, resulting in a gap at the contact portion. Consequently, it is possible that the radio wave leaks outside, or the noise increases.

In view of the foregoing, a second example has been proposed. The second prior art example will be described with reference to FIG. 45, which is an exploded perspective view of the main portion schematically representing the structure, and FIG. 46, which is a cross sectional view taken along the line XXXXVI-XXXXVI of FIG. 45.

In the second prior art example, an opening 103a is provided in substrate 103, and waveguide septum 101a is extended to pass through the opening 103a of substrate 103. Radio wave reflecting portion septum 102f of the first prior art example is not formed at radio wave reflecting portion 102, and, alternatively, a hole 102i receiving the end surface of the extended waveguide septum 101a is formed.

Further, in the second prior art example, the hole 102i of radio wave reflecting portion 102 is communicated with the outside. Therefore, in order to prevent in-coming/out-going of radio wave from/to the outside, the gap between waveguide septum 101a and hole 102i is sealed by a conductive member 107 formed, for example, of a sheet metal having elasticity.

According to the second prior art example, even when there is a variation in dimensional accuracy at the time of mass production, conductive member 107 deforms, and therefore, it becomes easier to attain sure contact between the entire end surfaces of waveguide 101 and radio wave reflecting portion 102 with the grounding surfaces of substrate 103.

FIG. 47A is a perspective view showing the appearance of conductive member 107 shown in FIG. 46, FIG. 47B is a cross section taken along the line XXXXVIIB-XXXXVIIB of FIG. 47A, and FIG. 47C is a cross section showing a state in which conductive member 107 and septum 101a are attached to hole 102i.

Conductive member 107 will be described with reference to FIGS. 47A, 47B and 47C. Conductive member 107 has an engaging portion 107a that abuts radio wave reflecting surface 102a, and an inward cutout portion 107b having a tip end abutting septum 101a. The width A of FIG. 47A is set to be slightly larger than the width B of hole 102i of radio wave reflecting portion 102 shown in FIG. 47C. Such a structure is to prevent slipping off during assembly, and to attain sure electrical conduction between septum 101a and radio wave reflecting portion 102.

The second prior art example described above, however, has the following problem.

In the second prior art example, a separate conductive member 107 is used. Therefore, cost of the raw material increases, and considering the manufacturing steps, the step of attaching conductive member 107 increases. Thus, the cost is significantly increased.

Further, in the manufacturing step at mass production, it may be possible that attachment of conductive member 107 is unsatisfactory. In such a case, radio wave may be leaked outside through hole 102i or the noise may be increased, and therefore increase of the ratio of defective products and degradation of products are expected. Further, there may be a gap around the cutout portion 107b of conductive member 107, as shown in FIGS. 47A to 47C, and the gap between waveguide septum 101a and hole 102i cannot be sealed by the two side surfaces at which cutout portion 107b is not formed. In other words, it is difficult to actually seal the gap by the structure that employs a separate member to fill the gap between septum 101a and hole 102i, possibly resulting in degradation of product characteristics.

### SUMMARY OF THE INVENTION

Therefore, an object of the present invention is to provide a polarization wave separating structure, a radio wave receiving converter and an antenna apparatus that can be manufactured at a low cost, suitable for mass production and have high performance.

Briefly stated, the present invention provides a polarized wave separating structure, including: a substrate portion having an opening and provided with a pair of radio wave receiving portions; a waveguide arranged on one side of the substrate portion and having a septum provided therein; and a radio wave reflecting portion arranged on the other side of the substrate portion and having a radio wave reflecting surface provided on an inner side; wherein the septum portion is extended through the opening to the radio wave reflecting portion so as to separate respective polarized waves received by the pair of radio wave receiving portions; and a space between the septum portion and the radio wave reflecting portion is set such that an end surface of the wave guide on the substrate side is surely in contact with a grounding surface provided on one surface of the substrate portion and an end surface of the radio wave reflecting portion on the side of the substrate portion is surely in contact with a grounding surface provided on the other surface of the substrate portion.

Therefore, according to the present invention, a polarized wave separating structure can be provided that can attain fully satisfactory polarized wave separating characteristic without leakage of the radio wave to the outside or increase of noise, that have simple structure enabling improvement of satisfactory product ratio of mass production and that can be manufactured at a low cost and is suitable for mass production.

More preferably, when the space between the septum portion and the radio wave reflecting portion is made very small with respect to the wavelength of the radio wave, the radio wave hardly leaks through the space from one to the other of the waveguide spaces parted by the septum portion. Namely, even with such a space, fully satisfactory polarized wave separating characteristic can be attained. Therefore, even when there is a variation at the time of mass production, the end surface of the waveguide on the side of the substrate is surely brought into contact with the grounding surface formed on one surface of the substrate portion and the end surface of the radio wave reflecting portion on the side of the substrate portion is surely brought into contact with the grounding surface formed on the other surface of the substrate portion, and hence, unlike the first prior art example described above, leakage of radio wave to the outside or increase of noise can be prevented.

Further, the structure is not the type of the second prior art example in which the gap between the septum portion of the waveguide and the hole of the radio wave reflecting portion is filled by a separate member. Therefore, the cost including the cost of raw materials and manufacturing can be reduced, and increase in the ratio of defective products and degradation of product characteristics caused by leakage of radio wave to the outside or increased noise can be prevented.

Preferably, the space is set such that the septum portion and the radio wave reflecting portion are not in contact with each other.

When the space is set so as to prevent contact between the septum portion and radio wave reflecting portion, the end surface of the waveguide on the side of the substrate portion can more surely be brought into contact with the grounding surface provided on one surface of the substrate portion, and the end surface of the radio wave reflecting portion on the side of substrate portion can more surely be brought into contact with the grounding surface provided on the other surface of the substrate portion.

More preferably, the septum portion is provided not to be in contact with an inner surface of the opening.

By this structure in which the septum portion is not in contact with the inner surface of the opening of the substrate portion, it becomes possible to bring the end surface of the waveguide on the side of the substrate portion more surely into contact with the grounding surface provided on one surface of the substrate portion and to bring the end surface of the radio wave reflecting portion on the side of the substrate portion to be in contact with the grounding surface provided on the other surface of the substrate portion.

More preferably, a slot to which the septum portion is partially inserted is provided on the inner surface of the radio wave reflecting portion. The slot may be provided on the radio wave reflecting surface of the radio wave reflecting portion.

By this structure in which a slot is provided on the inner surface of the radio wave reflecting portion to which an end surface of the septum portion is inserted, leakage of the radio wave from one to the other of the waveguide spaces parted by the septum portion can more effectively be suppressed, and the polarized wave separating characteristic can be improved.

More preferably, a protruded portion is provided on the inner surface of the radio wave reflecting portion, and a slot to which the protruded portion is inserted is provided on the end surface of the septum portion. The protrude portion may be provided on an inner surface of a cylindrical portion of the radio wave reflecting portion.

By providing a protruded portion on the inner surface of the radio wave reflecting portion and providing a slot to which the protruded portion is inserted on the end surface of the septum portion, leakage of the radio wave from one to the other one of the waveguide spaces parted by the septum portion can more effectively be suppressed, and the polarized wave separating characteristic can be improved.

In a structure in which a slot is provided on the inner surface of the cylindrical portion of the radio wave reflecting portion and the septum portion of the waveguide is inserted to the slot, it becomes necessary to change the shape of the opening of the substrate portion. In contrast, in the structure in which the protruded portion is provided on the inside of the cylindrical portion of the radio wave reflecting portion, such a change in shape of the substrate opening becomes unnecessary.

According to the present invention, a protruded portion is provided on an inner peripheral surface of the radio wave reflecting portion, and a slot for inserting the protrude portion is provided on the septum portion. The protruded portion may be provided on the inner surface of the radio wave reflecting surface, or of the cylindrical portion of the radio wave reflecting portion.

By providing a protruded portion on the inner surface of the radio wave reflecting portion and providing a slot to which the protruded portion is inserted on the septum portion, leakage of the radio wave from one to the other one of the waveguide spaces parted by the septum portion can more effectively be sup pressed, and the polarized wave separating characteristic can be improved.

In a structure in which a slot is provided on the inner surface of the cylindrical portion of the radio wave reflecting portion and the septum portion of the waveguide is inserted to the slot, it becomes necessary to change the shape of the opening of the substrate portion. In contrast, in the structure in which the protruded portion is provided on the inside of the cylindrical portion of the radio wave reflecting portion, such a change in shape of the substrate opening becomes unnecessary.

More preferably, the slot is formed to have a shape widening from the bottom toward the opening side.

When the slot has such a shape that widens from the bottom to the opening side, easy manufacturing by casting technique, for example by aluminum die cast, becomes possible.

More preferably, the slot is provided on the inner surface of the cylindrical portion of the radio wave reflecting portion, or at the end surface of the septum opposing to the cylindrical portion of the radio wave reflecting portion, and at least a part of the bottom portion of the slot is formed to have such a shape that widens from the radio wave reflecting surface side to the substrate side.

As the bottom portion of the slot has such a shape that widens from the side of the radio wave reflecting surface to the side of the substrate, easy manufacturing by casting technique, for example by aluminum die cast, becomes possible.

According to another aspect, the present invention provides a polarized wave separating structure, including: a substrate portion having an opening and provided with a pair of radio wave receiving portions; a waveguide arranged on one side of the substrate portion; and a radio wave reflecting portion arranged on the other side of the substrate portion and having a radio wave reflecting surface on an inner side and a septum provided therein; wherein the septum portion is extended through the opening to the side of the wave guide so as to separate respective polarized waves received by the pair of radio wave receiving portions, and a space between the septum portion and the waveguide is set such that an end surface of the waveguide on the side of the substrate portion is in contact with a grounding surface provided on one surface of the substrate portion and an end surface of the radio wave reflecting portion on the side of the substrate portion is in contact with a grounding surface provided on the other surface of the substrate portion.

Here, when the space between the septum portion and the waveguide is made very small with respect to the wavelength of the radio wave, the radio wave hardly leaks through the space from one to the other of the waveguide spaces parted by the septum portion. Namely, even with such a space, fully satisfactory polarized wave separating characteristic can be attained. Therefore, even when there is a variation at the time of mass production, the end surface of the waveguide on the side of the substrate is surely brought into contact with the grounding surface formed on one surface of the substrate portion and the end surface of the radio wave reflecting portion on the side of the substrate portion is surely brought into contact with the grounding surface formed on the other surface of the substrate portion, and hence, unlike the first prior art example described above, leakage of radio wave to the outside or increase of noise can be prevented.

Further, the structure is not the type of the second prior art example in which the gap between the septum portion of the waveguide and the hole of the radio wave reflecting portion is filled by a separate member. Therefore, the cost including the cost of raw materials and manufacturing can be reduced, and increase in the ratio of defective products and degradation of product characteristics caused by leakage of radio wave to the outside or increased noise can be prevented.

Therefore, according to the present invention, a polarized wave separating structure can be realized that attains fully satisfactory polarized wave separating characteristic without leakage of radio wave to the outside or increase of noise, that has a simple structure and improves ratio of satisfactory products of mass production and that can be manufactured at a low cost and hence suitable for mass production.

Preferably, the space is set such that the septum portion and the waveguide are not in contact with each other.

When the space is set so as to prevent contact between the septum portion and the waveguide, the end surface of the waveguide on the side of the substrate portion can more surely be brought into contact with the grounding surface provided on one surface of the substrate portion, and the end surface of the radio wave reflecting portion on the side of substrate portion can more surely be brought into contact with the grounding surface provided on the other surface of the substrate portion.

More preferably, the septum portion is provided to be not in contact with the inner surface of the opening.

By this structure in which the septum portion is not in contact with the inner surface of the opening of the substrate portion, it becomes possible to bring the end surface of the waveguide on the side of the substrate portion more surely into contact with the grounding surface provided on one surface of the substrate portion and to bring the end surface of the radio wave reflecting portion on the side of the substrate portion into contact with the grounding surface provided on the other surface of the substrate portion.

More preferably, a slot to which the septum portion is partially inserted is formed on the inner surface of the waveguide.

By the structure in which a slot is provided on the inner surface of the waveguide to which the septum portion is partially inserted, leakage of the radio wave from one to the other of the waveguide spaces parted by the septum portion can more effectively be suppressed, and the polarized wave separating characteristic can be improved.

More preferably, a protruded portion is formed on the inner surface of the waveguide, and a slot to which the protruded portion is inserted is formed in the septum portion.

By providing a protruded portion on the inner surface of the waveguide and providing a slot to which the protruded portion is inserted on the septum portion, leakage of the radio wave from one to the other one of the waveguide spaces parted by the septum portion can more effectively be suppressed, and the polarized wave separating characteristic can be improved.

More preferably, the slot is formed to have such a shape that widens from the bottom portion to the opening side.

When the slot has such a shape that widens from the bottom to the opening side, easy manufacturing by casting technique, for example by aluminum die cast, becomes possible.

More preferably, the bottom portion of the slot is formed to have such a shape that widens from the radio wave entrance side of the waveguide to the substrate side.

As the bottom portion of the slot has such a shape that widens from the the radio wave entrance side of the waveguide to the side of the substrate, easy manufacturing by casting technique, for example by aluminum die cast, becomes possible.

According to a still further aspect, the present invention provides a polarized wave separating structure, including: a substrate portion having an opening and provided with a pair of radio wave receiving portions; a waveguide arranged on one side of the substrate portion and having a septum provided therein; and a radio wave reflecting portion arranged on the other side of the substrate portion and having a radio wave reflecting surface provided on an inner side and a septum provided therein; wherein both septum portions are arranged opposed to each other to separate respective polarized waves received by the pair of radio wave receiving portions; and the space between the two septum portions is set such that an end surface of the waveguide on the side of the substrate is surely in contact with a grounding surface provided on one surface of the substrate portion and an end surface of the radio wave reflecting portion on the side of the substrate portion is surely in contact with a grounding surface provided on the other surface of the substrate portion.

More preferably, when the space between the two septum portions is made very small with respect to the wavelength of the radio wave, the radio wave hardly leaks through the space from one to the other of the waveguide spaces parted by the septum portion. Namely, even with such a space, fully satisfactory polarized wave separating characteristic can be attained. Therefore, even when there is a variation at the time of mass production, the end surface of the waveguide on the side of the substrate is surely brought into contact with the grounding surface formed on one surface of the substrate portion and the end surface of the radio wave reflecting portion on the side of the substrate portion is surely brought into contact with the grounding surface formed on the other surface of the substrate portion, and hence, unlike the first prior art example described above, leakage of radio wave to the outside or increase of noise can be prevented.

Further, the structure is not the type of the second prior art example in which the gap between the septum portion of the waveguide and the hole of the radio wave reflecting portion is filled by a separate member. Therefore, the cost including the cost of raw materials and manufacturing can be reduced, and increase in the ratio of defective products and degradation of product characteristics caused by leakage of radio wave to the outside or increased noise can be prevented.

Therefore, according to the present invention, a polarized wave separating structure can be provided that can attain fully satisfactory polarized wave separating characteristic without leakage of the radio wave to the outside or increase of noise, that have simple structure enabling improvement of satisfactory product ratio of mass production and that can be manufactured at a low cost and is suitable for mass production.

More preferably, the space is set such that the septum portion of the waveguide is not in contact with the septum portion of the radio wave reflecting portion.

When the space is set so as to prevent contact between the septum portion of the waveguide and the septum portion of the radio wave reflecting portion, the end surface of the waveguide on the side of the substrate portion can more surely be brought into contact with the grounding surface provided on one surface of the substrate portion, and the end surface of the radio wave reflecting portion on the side of substrate portion can more surely be brought into contact with the grounding surface provided on the other surface of the substrate portion.

More preferably, both the septum portion of the waveguide and the septum portion of the radio wave reflecting portion are provided to be not in contact with the inner surface of the opening.

By this structure in which neither the septum portion of the waveguide nor the septum portion of the radio wave reflecting portion is not in contact with the inner surface of the opening of the substrate portion, it becomes possible to bring the end surface of the waveguide on the side of the substrate portion more surely into contact with the grounding surface provided on one surface of the substrate portion and to bring the end surface of the radio wave reflecting portion on the side of the substrate portion into contact with the grounding surface provided on the other surface of the substrate portion.

More preferably, both the septum portion of the waveguide and the septum portion of the radio wave reflecting portion are arranged not to pass through the opening.

By the structure in which both the septum portion of the waveguide and the septum portion of the radio wave reflecting portion do not pass through the opening of the substrate portion, the septum portions can be extended to positions of the end surfaces on the side of the substrate portion of the cylindrical portion of the waveguide and the cylindrical portion of the radio wave reflecting portion. Therefore, the polarized wave separating characteristic can be improved.

Preferably, of the opposing end surfaces of the waveguide side septum portion and the radio wave reflecting side septum portion, one is provided with a protruded portion and the other is provided with a slot to which the protruded portion is inserted.

In this manner, as a protruded portion is provided on an end surface of one of the septum portions and a slot for receiving the protruded portion is provided on the end surface of the other septum portion, leakage of the radio wave from one to the other of the waveguide spaces parted by the septum portions can more effectively be suppressed, and the polarized wave separating characteristic can be improved.

More preferably, the slot is formed to have such a shape that widens from the bottom portion to the opening side.

When the slot has such a shape that widens from the bottom to the opening side, easy manufacturing by casting technique, for example by aluminum die cast, becomes possible.

More preferably, on one of the pair of radio wave receiving portions provided on the substrate, a reflection free terminating portion absorbing the received polarized wave is provided.

As the reflection free terminating portion is provided, the problem of unsatisfactory grounding contact between the septum of the radio wave reflecting portion and the grounding surface of the substrate can be solved.

Preferably, the reflection free terminating portion is grounded through a terminating resistor. As the terminating resistance is provided, the polarized wave that is not to be received can sufficiently be attenuated.

More preferably, the reflection free terminating portion includes a receiving probe to which the terminating resistor is connected, and a stub matching portion formed between the receiving probe and the terminating resistor.

Because of the stub matching portion, the resistance can be adjusted to general resistance, and therefore, the polarized wave that is not to be received can sufficiently be attenuated, and the cost can be reduced.

According to a still further aspect, the present invention provides a polarized wave separating structure, including: a substrate portion having an opening and provided with one radio wave receiving portion; a waveguide arranged on one surface side of the substrate portion and provided with a septum portion therein; and a radio wave reflecting portion arranged on the other surface side of the substrate portion and having a radio wave reflecting portion formed on an inner side; wherein the waveguide, the substrate portion and the radio wave reflecting portion form a waveguide space, the septum portion passes through the opening and extends to the radio wave reflecting portion to divide the radio wave reflecting surface into two, the septum portion parts the waveguide space into one waveguide space in which the one radio wave receiving portion is positioned and the other waveguide space, and a reflection free terminating portion is formed in the other waveguide space.

As only one radio wave receiving portion for the polarized wave to be received is provided, the radio wave that is not to be received do not go over the substrate as a reflected wave.

More preferably, one part of the waveguide separated into two by the septum at the end portion on the substrate portion side is closed with its inner surface providing a reflecting surface, and the other part separated by the septum is opened to transmit the polarized wave to the succeeding stage, the substrate portion has an opening of the same shape as the opening of the waveguide, and the radio wave reflecting portion is formed to have the same shape as the opening of the waveguide.

More preferably, one part of the waveguide that is divided into two by the septum at the end portion on the substrate portion side is closed with its inner surface forming a reflecting surface, and the other part separated by the septum opened to transmit the polarized wave to the succeeding stage, the septum of the waveguide passes through the substrate opening to extend to the radio wave reflecting portion of the succeeding stage, and the shape of the substrate opening and the shape of the opening of the radio wave reflecting portion of the succeeding stage correspond to the shape of the opening at the waveguide and the cross sectional shape of the septum of the waveguide.

More preferably, the reflection free terminating portion is formed at the reflecting surface provided by closing one of the separated portions of the waveguide.

As the reflection free terminating portion is attached, attenuation is attained in the waveguide space, and hence, reflection wave can more effectively be suppressed.

Preferably, the reflection free termination portion formed at the reflecting surface is a plate-shaped radio wave absorber, and hence cost reduction is possible.

The reflection free terminating portion formed at the reflecting surface is a semi-columner radio wave absorber, and generation of reflective wave can more effectively be suppressed.

More preferably, the reflection free terminating portion formed at the reflecting surface is a semi-conical radio wave absorber, better adjustment is attained when the polarized wave enters from the space to the radio wave absorber, and the reflective wave is reduced.

More preferably, the radio wave absorber of the refection free terminating portion is a resistance plate. As the resistance plate attenuates only the polarized wave that is parallel to the resistance plate, it is effective to attenuate only the polarized wave that is not to be received.

More preferably, a cutout portion is formed at one end of the resistance plate on the side of the waveguide that is opened. The cutout portion attains adjustment when the polarized wave enters from the space to the resistance plate, and the reflective wave generated at that portion can be suppressed.

Preferably, a radio wave receiving converter includes any of the above described polarized wave separating structures.

Therefore, a radio wave receiving converter can be realized that attains fully satisfactory polarized wave separating characteristic without leakage of radio wave to the outside or increase of noise, that has a simple structure and improves the ratio of satisfactory products of mass production and that can be manufactured at a low cost and is suitable for mass production.

Further, an antenna apparatus is provided that includes the above described radio wave receiving converter and a reflecting parabola portion that reflects the received radio wave and guides the reflected radio wave to the radio wave receiving converter.

Accordingly, an antenna apparatus can be realized that can attain fully satisfactory polarized wave separating characteristic without leakage of radio wave to the outside or increase of noise, that has a simple structure and improves the ratio of satisfactory products of mass production, and that can be manufactured at a low cost and is suitable for mass production.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustration of a receiving converter and an antenna apparatus in accordance with one embodiment of the present invention.

FIG. 2 is an exploded perspective view showing the polarized wave separating structure in accordance with Embodiment 1 of the present invention.

FIG. 3 is a partial cross section taken along the line III-III of FIG. 2.

FIG. 4 is a partial cross section taken along the line IV-IV of FIG. 2.

FIG. 5 is a perspective view of a main portion representing a schematic structure of the radio wave reflecting portion in accordance with Embodiment 2 of the present invention.

FIG. 6 is a partial vertical section representing a schematic structure of the polarized wave separating structure in accordance with Embodiment 2.

FIG. 7 is a partial cross section taken along the line VII-VII of FIG. 6.

FIG. 8 is a partially enlarged cross section of a region a of FIG. 6.

FIG. 9 is a partially enlarged cross section of the region α of FIG. 6.

FIGS. 10A and 10B are illustrations representing a measurement system for measuring polarized wave separating characteristic of Embodiment 2.

FIG. 11 is a table of comparison of the polarized wave separating characteristic between Embodiment 2 and the second prior art example.

FIG. 12 is a graph representing the result of comparison of polarized wave separating characteristic between Embodiment 2 and the second prior art example.

FIGS. 13A to 13C represent the polarized wave separating structure in accordance with Embodiment 3 of the present invention, in which FIG. 13A is a partial vertical section, and FIGS. 13B and 13C are partially enlarged cross sections of the region β of FIG. 13A.

FIGS. 14A and 14B represent a polarized wave separating structure in accordance with Embodiment 4 of the present invention, in which FIG. 14A is a partial perspective view representing a schematic structure of the radio wave reflecting portion, and FIG. 14B is a cross section representing the polarized wave separating structure.

FIG. 15 is a partial cross section taken along the line XV-XV of FIG. 14B.

FIG. 16 is a cross section representing the polarized wave separating structure in accordance with Embodiment 4.

FIG. 17 is a cross section representing the polarized wave separating structure in accordance with Embodiment 5 of the present invention.

FIG. 18 is a partial cross section taken along the line XVIII-VXIII of FIG. 17.

FIG. 19 is a cross section representing the polarized wave separating structure in accordance with Embodiment 5 of the present invention.

FIG. 20 is an exploded perspective view representing the polarized wave separating structure in accordance with Embodiment 6 of the present invention.

FIG. 21 is a partial cross section taken along the line XXI-XXI of FIG. 20.

FIGS. 22A and 22B are cross sections representing the polarized wave separating structure in accordance with Embodiment 7 of the present invention.

FIG. 23 is a partial cross section taken along the line XXIII-XXIII of FIG. 22A.

FIGS. 24A and 24B are cross sections representing the polarized wave separating structure in accordance with Embodiment 8 of the present invention.

FIG. 25 is a partial cross section taken along the line XXV-XXV of FIG. 24A.

FIG. 26 is an exploded perspective view representing the polarized wave separating structure in accordance with Embodiment 9 of the present invention.

FIG. 27 is a partial cross section taken along the line XXVII-XXVII of FIG. 26.

FIGS. 28A to 28C represent the polarized wave separating structure in accordance with Embodiment 10 of the present invention, in which FIG. 28A is a partial vertical section, and FIGS. 28B and 28C are partially enlarged cross section of the region γ of FIG. 28A.

FIG. 29 is an exploded perspective view of a main portion representing a schematic structure of Embodiment 11.

FIG. 30A is a top view of a substrate, and FIG. 30B is a cross section taken along the line XXXB-XXXB of FIG. 29.

FIG. 31 is a top view of the substrate of the polarized wave separator in accordance with Embodiment 12.

FIG. 32A is an exploded perspective view of a main portion representing the polarized wave separating structure in accordance with Embodiment 13 of the present invention, and FIG. 32B is a cross section taken along the line XXXIIB-XXXIIB of FIG. 32A.

FIG. 33 is an exploded perspective view of a main portion representing the polarized wave separating structure in accordance with Embodiment 14 of the present invention.

FIG. 34A is a top view of the substrate, and FIG. 34B is a cross section taken along the line XXXIVB-XXXIVB of FIG. 33.

FIG. 35 is an exploded perspective view of a main portion representing the polarized wave separating structure in accordance with Embodiment 14 of the present invention.

FIG. 36A is a top view of the substrate of the polarized wave separator, and FIG. 36B is a cross section taken along the line XXXVIB-XXXVIB of FIG. 35.

FIG. 37A is a horizontal cross section of a waveguide in another example of the polarized wave separator, FIG. 37B is a vertical section thereof, and FIG. 37C represents a columner radio wave absorber.

FIG. 38A is a horizontal cross section of a waveguide in a still another example of the polarized wave separator, FIG. 38B is a vertical section thereof, and FIG. 38C represents a conical radio wave absorber.

FIG. 39A is a horizontal cross section of a waveguide in a still another example of the polarized wave separator, and FIG. 39B is a vertical section thereof.

FIG. 40A is a horizontal cross section of a waveguide in a still another example of the polarized wave separator, and FIG. 40B is a vertical section thereof.

FIG. 41 is a perspective view showing an appearance of a parabola antenna provided with a satellite broadcast receiving converter mounting the polarized wave separator in accordance with the present invention.

FIG. 42 is a cross section of the satellite broadcast receiving converter mounting the polarized wave separator of the present invention.

FIG. 43 is an exploded perspective view representing a polarized wave separating structure in accordance with the first prior art example.

FIG. 44 is a partial cross section taken along the line XXXXIV-XXXXIV of FIG. 43.

FIG. 45 is an exploded perspective view showing the polarized wave separating structure in accordance with the second prior art example.

FIG. 46 is a partial cross section taken along the line XXXXVI-XXXXVI of FIG. 45.

FIGS. 47A to 47C represent the structure of the conductive member 107 in accordance with the second prior art example, in which FIG. 47A is a perspective view, FIG. 47B is a cross section taken along the line XXXXVIIB-XXXXVIIB, and FIG. 47C is a cross section showing the conductive member 107 and septum 101a attached to hole 102i.

### DESCRIPTION OF THE PREFERRED EMBODIMENTS

Embodiments of the present invention will be described with reference to the figures.

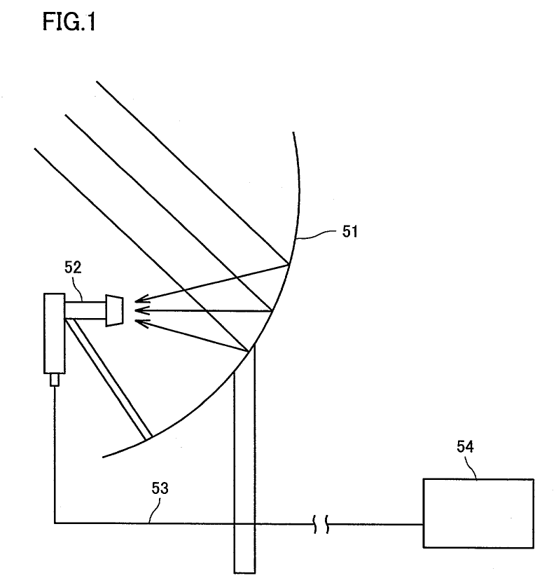

First, referring to FIG. 1, a receiving converter (LNB: Low Noise Blockdown Converter) for receiving radio waves from a satellite and an antenna apparatus will be described. The radio waves from the satellite are reflected and concentrated by a reflecting parabola portion 51, guided to and taken in by a radio wave receiving converter 52. Reflecting parabola portion 51 and radio wave receiving converter 52 form the antenna apparatus.

In the embodiments described in the following, the radio waves from the satellite are circularly polarized waves including d-polarized wave and l-polarized wave. Converter 52 separates these two components, amplifies each of the components, and converts the radio waves in the band of several GHz to signals of 1 GHz band. The converted signals are transmitted through a cable 53 to an indoor receiving device 54.

In the embodiments, polarized wave separating structures used for such a radio wave receiving converter or an antenna apparatus will be described.

Embodiment 1

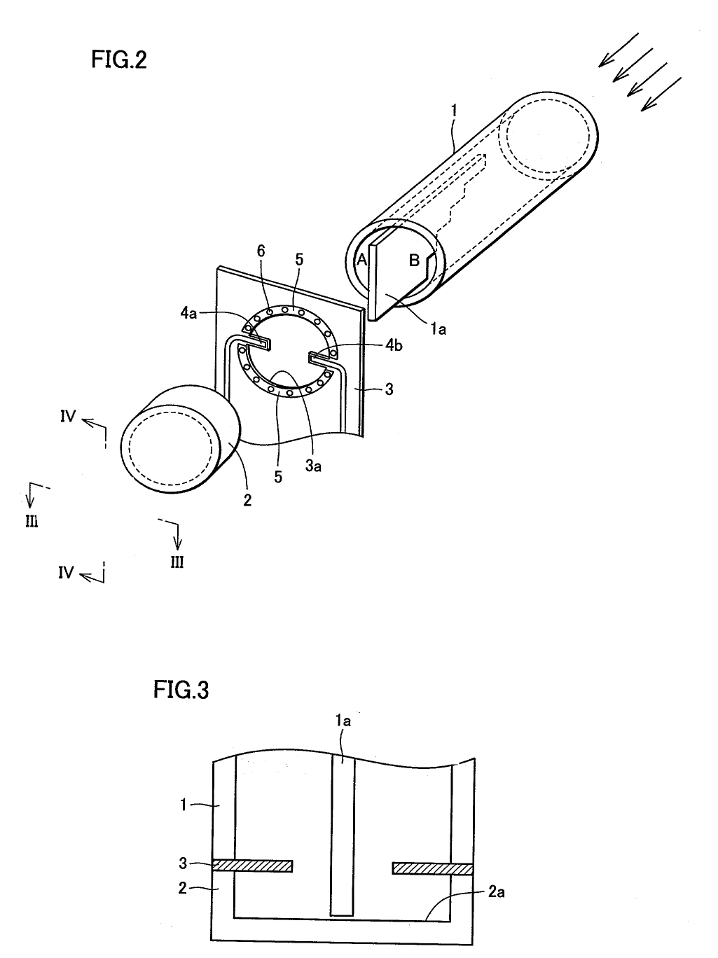

A polarized wave separating structure in accordance with Embodiment 1 of the present invention will be described with reference to FIGS. 2 to 4.

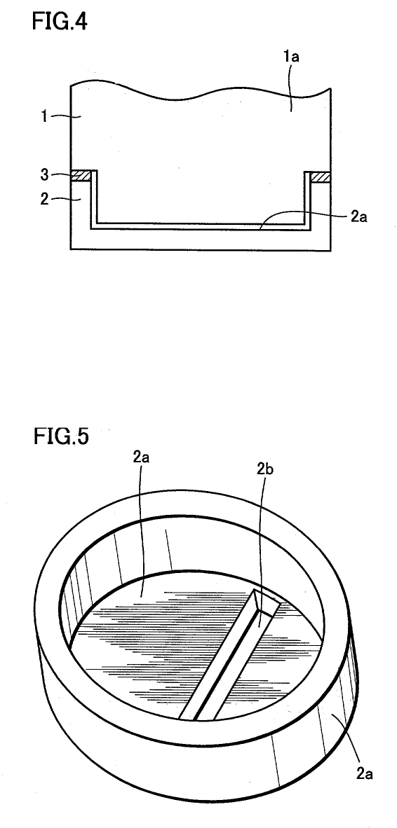

FIG. 2 is an exploded perspective view of a main portion showing a schematic structure of Embodiment 1, FIG. 3 is a partial cross section taken along the line III-III of FIG. 2, and FIG. 4 is a partial cross section taken along the line IV-IV of FIG. 2.

The polarized wave separating structure mainly includes a waveguide 1, a radio wave reflecting portion 2 and a substrate 3.

Substrate 3 has an opening 3a formed therein. On substrate 3, a pair of radio wave receiving probes (radio wave receiving portions) 4a and 4b are formed in the form of conductive film patterns, at opposing positions to protrude into the opening 3a. The pair of radio wave receiving probes 4a and 4b are formed on that surface of substrate 3 on which radio wave reflecting portion 2 is positioned. Substrate 3 is formed of an insulative substrate such as an insulative resin substrate or a glass epoxy substrate, with a pattern of a conductive film of copper, for example, formed thereon.

At portions of substrate 3 except for the conductive film patterns forming the radio wave receiving probes 4a and 4b, a grounding surface 5 to be in contact with radio wave reflecting portion 2 is formed by a conductive film pattern, around opening 3a. Further, on the surface of substrate 3 opposite to the grounding surface 5, a grounding surface (not shown) to be in contact with an end portion of waveguide 1 is formed by a conductive film pattern. The grounding surface in contact with the end surface of radio wave reflecting portion 2 and the grounding surface in contact with the end surface of waveguide 1 are connected to each other by means of through holes 6. Thus, through substrate 3, waveguide 1 and radio wave reflecting portion 2 are kept at the grounding potential. The wiring portion of the conductive film patterns forming radio wave receiving probes 4a and 4b formed on substrate 3 are electrically insulated from respective grounding surfaces, waveguide 1 and radio wave reflection portion 2.

On one side of substrate 3, waveguide 1 is arranged. Waveguide 1 is provided with a septum (septum portion) 1a with a stepped portion. Septum 1a extends through the opening 3a of substrate 3 to radio wave reflecting portion 2. In the present embodiment, waveguide 1 and septum 1a are formed integrally. For example, these may be formed as one piece by casting technique using, for example, aluminum die cast.

Radio wave reflecting portion 2 includes a cylindrical portion and a flat plate portion at an end, which is approximately parallel to the substrate 3, and inside the reflecting portion, the inner surface of the plate shaped portion serves as a radio wave reflecting surface 2a. Radio wave reflecting portion 2 can also be formed by casting technique using, for example, aluminum die cast.

In the present embodiment, a space between septum 1a and the inner surface (inside surface) of radio wave reflecting portion 2 is set such that the end surface of waveguide 1 on the side of substrate 3 is surely in contact with the grounding surface provided on one surface of substrate 3 and the end surface of radio wave reflecting portion 2 on the side of substrate 3 is surely in contact with grounding surface 5 provided on the other surface of substrate 3, while septum 1a is not in contact with radio wave reflecting portion 2.

More specifically, in the present embodiment, a structure is provided in which the end surface of waveguide 1 on the side of the substrate 3 is in tight contact without any gap with and along the grounding surface provided on one surface of substrate 3 and the end surface of radio wave reflecting portion 2 on the side of substrate 3 is in tight contact without any gap with and along the grounding surface 5 provided on the other surface of substrate 3, whereby radio wave does not leak to the outside and any noise component does not enter from the outside, at the contact portion between the end surface of waveguide 1 on the side of substrate 3 and the grounding surface provided on one surface of substrate 3 and at the contact portion between the end surface of radio wave reflecting portion 2 on the side of substrate 3 and grounding surface 5 provided on the other surface of substrate 3.

In the present embodiment, septum 1a is provided not in contact with the inner surface of opening 3a, so that the end surface of waveguide 1 on the side of substrate 3 is surely in contact with the grounding surface provided on one surface of substrate 3 and the end surface of radio wave receiving portion 2 on the side of substrate 3 is surely in contact with grounding surface 5 provided on the other surface of substrate 3.

More specifically, as shown in FIGS. 3 and 4, the end surface of septum 1a is not in contact with the radio wave reflecting surface 2a or the inner surface (inside surface) of the cylindrical portion of the radio wave reflecting portion 2. Further, as shown in FIGS. 3 and 4, the end surface of septum 1a is not in contact with the inner surface (inside surface) of opening 3a of substrate 3, either. Generally, such a radio wave receiving converter has the inside made airtight. Therefore, between septum 1a and radio wave reflecting portion 2 and between septum 1a and opening 3a, there is no separate member interposed, but gas, such as air, exists only.

In such a structure, waveguide 1, substrate 3 and radio wave reflecting portion 2 form a waveguide space, and the waveguide space is parted by septum portion 1a into one waveguide space in which one of the pair of radio wave receiving probes 4a and 4b is positioned, and the other waveguide space in which the other radio wave receiving probe is positioned. In the waveguide space, substrate 3 and radio wave reflecting surface 2a are arranged to be approximately vertical to the direction of progress of the radio wave, while septum 1a is arranged along the direction of progress of the radio wave.

The operation of the above described polarized wave separating structure is as follows. When circularly polarized wave as an input radio wave enters from the direction of the arrow shown in FIG. 2, the circularly polarized wave caught by waveguide 1 is converted to a linearly polarized wave by the stepped portion of septum 1a. Here, as the circularly polarized wave includes d-polarized wave and l-polarized wave, the linearly polarized wave resulting from the conversion includes a component resulting from conversion of the d-polarized wave and a component resulting from the conversion of the l-polarized wave.

The stepped portion of septum 1a functions as a circularly polarized wave-linearly polarized wave converting portion for changing the circularly polarized wave to linearly polarized wave. The shape is not limited to steps, and it may be tapered, widening linearly from the radio wave entrance side to the substrate 3, for example. Namely, any shape may be used provided that it functions as the circularly polarized wave-linearly polarized wave converting portion. The description as to the stepped portion of the septum is common to any of the following embodiments.

Thereafter, of the two parted waveguide spaces parted by septum 1a, one waveguide space (waveguide space A) captures the linearly polarized component (component A) resulting from conversion of the d-polarized wave, and the other waveguide space (waveguide space B) captures the linearly polarized component (component B) resulting from conversion of the l-polarized wave.

Component A separated in this manner passes through opening 3a, is reflected at radio wave reflecting portion 2a, and received by radio wave receiving probe 4a, as one of the pair of radio wave receiving probes 4a and 4b. Similarly, component B passes through opening 3a, is reflected at radio wave reflecting portion 2a and received by the other radio wave receiving probe 4b.

The components A and B of respective linearly polarized waves received by the pair of radio wave receiving probes 4a and 4b are input to a prescribed circuit (not shown) provided in substrate 3 of the converter.

In the present embodiment, as already described, the space between septum 1a and the inner surface (inside surface) of radio wave reflecting portion 2 is set such that septum 1a is not in contact with radio wave reflecting portion 2, so that the end surface of waveguide 1 on the side of substrate 3 is surely in contact with the grounding surface provided on one surface of substrate 3, and the end surface of radio wave reflecting portion 2 on the side of substrate 3 is surely in contact with grounding surface 5 provided on the other surface of substrate 3.

In the present embodiment, the distance between the inner surface (inside surface) of radio wave reflecting portion 2 and the end surface of septum 1a opposing thereto is designed to be 0.2 mm to 0.3 mm. This is determined in consideration that, when waveguide 1 including septum 1a and radio wave reflecting portion 2 are formed by casting technique such as aluminum die cast, error in dimensional accuracy is generally ±0.05 mm. More specifically, assuming that there is an error of +0.05 mm on the side of waveguide 1 and +0.05 mm on the side of radio wave reflecting portion 2, the error in total is +0.1 mm. In an actual product, waveguide 1 and radio wave reflecting portion 2 are fixed by screws with substrate 3 interposed. By the screwing, substrate 3 is compressed to some extent, resulting in dimensional variation at the time of mass production. Therefore, in the present embodiment, in design, the distance between the inner surface (inside surface) of radio wave reflecting portion 2 and the end surface of septum 1a opposing thereto is set to be at least 0.2 mm. When the design value is at least 0.2 mm, the space between septum 1a of waveguide 1 and radio wave reflecting portion 2 of about 1 mm or larger can be ensured, even when there is a variation in mass production. Therefore, the end surface of waveguide 1 on the side of substrate 3 can more surely be brought into contact with the grounding surface provided on one surface of substrate 3, and the end surface of radio wave reflecting portion 2 on the side of substrate 3 can more surely be brought into contact with the grounding surface 5 provided on the other surface of substrate 3.

The wavelength of the radio wave (microwave) used for satellite broadcasting or satellite communication is about several cm. The distance between the inner surface (inside surface) of radio wave reflecting portion 2 and the end surface of septum 1a opposing thereto have only to be sufficiently smaller than the wavelength. Therefore, in the present embodiment, the value is set to be at most 0. 3 mm. Considering the above described dimensional error, the distance would be at most about 0.4 mm. With such a value, fully satisfactory polarized wave separating characteristic can be attained.

In this manner, according to the present embodiment, even when there is a variation in mass production, the end surface of waveguide 1 on the side of substrate 3 is surely in contact with the grounding surface provided one surface of substrate 3, and the end surface of radio wave reflecting portion 2 on the side of substrate 3 can be surely in contact with the grounding surface 5 provided on the other surface of substrate 3.

As a result, leakage of the radio wave to the outside of the waveguide space or increase of noise can be suppressed, while maintaining fully satisfactory polarized wave separating characteristic.

Further, unlike the second prior art example described above, a separate member for connecting the waveguide and the radio wave reflecting portion is unnecessary. Therefore, cost and time necessary for manufacture can be reduced. For example, as compared with the second prior art example described above, in the process of mass production and mounting for forming the waveguide space and the polarized wave separating structure, the cost necessary for manufacture can be reduced by about 10%, and the time necessary for manufacture can be reduced by about 50%. Further, as the structure is simple, manufacturing is facilitated, and the ratio of satisfactory products of mass production can be improved.

Embodiment 2

The polarized wave separating structure in accordance with Embodiment 2 of the present invention will be described with reference to FIGS. 5 to 13.

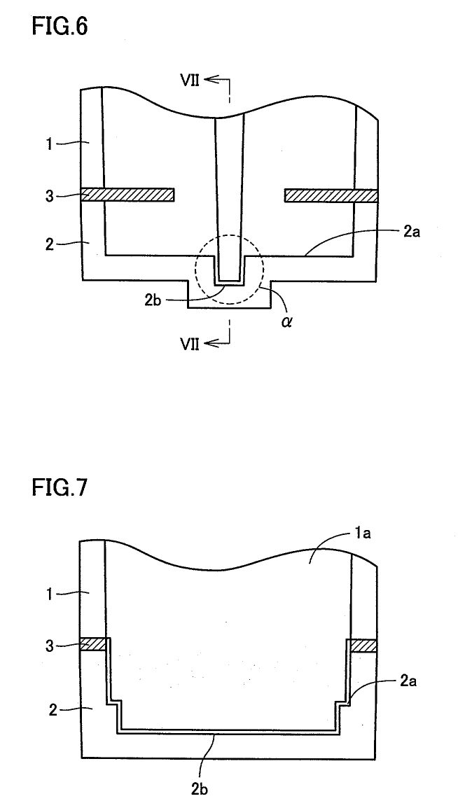

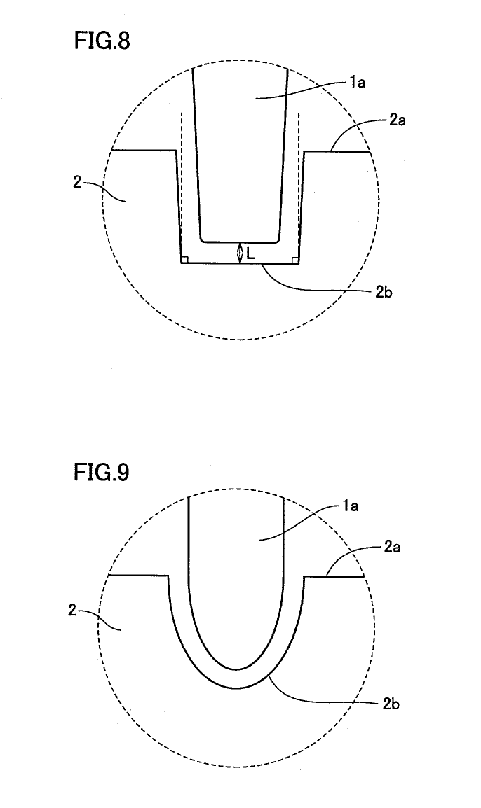

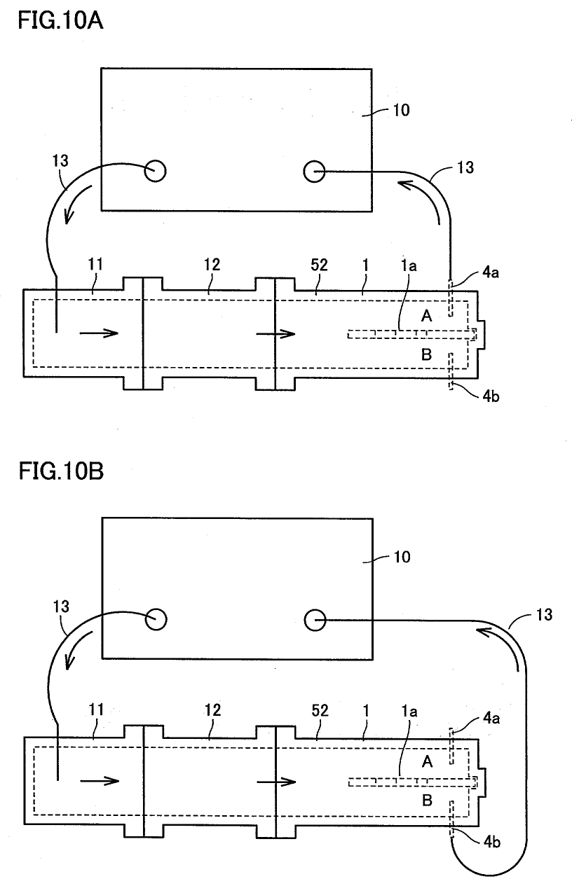

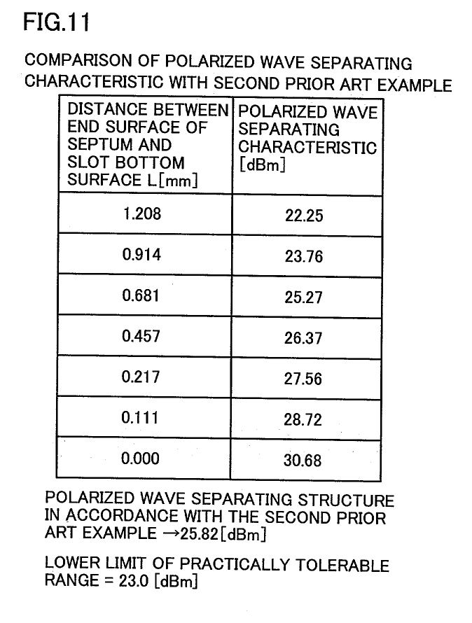

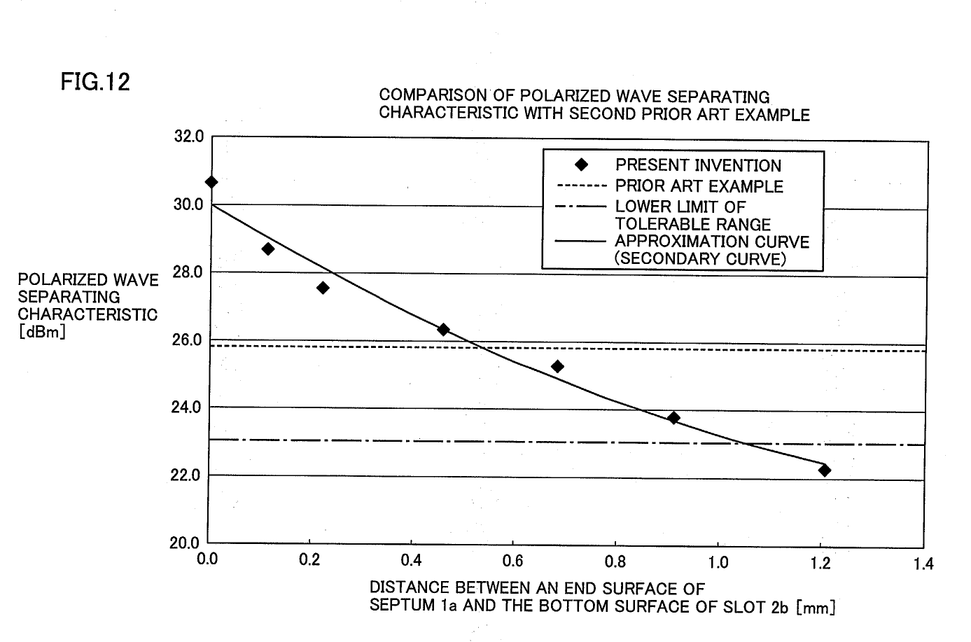

FIG. 5 is a perspective view of a main portion representing the schematic structure of radio wave reflecting portion 2 in accordance with the present embodiment, FIG. 6 is a partial cross section of the polarized wave separating structure using the radio wave reflecting portion 2, and FIG. 7 is a partial cross section taken along the line VII-VII of FIG. 6. FIGS. 8 and 9 are partially enlarged views of the region a of FIG. 6, FIGS. 10A and 10B are illustrations representing systems for measuring the polarized wave separating characteristic of the present embodiment, and FIGS. 11 and 12 represent comparison of polarized wave separating characteristic of the present embodiment and the second prior art example described above.

Embodiment 2 differs from Embodiment 1 described above mainly in that a slot 2b is provided at the radio wave reflecting surface 2a of radio wave reflecting portion 2, and that a part of septum 1a of waveguide 1 is further extended to be inserted to the slot 2b while radio wave reflecting portion 2 and septum 1a are not in contact with each other. Unlike hole 102i of the second prior art example described above, slot 2b is not penetrating through the radio wave reflecting portion to expose the waveguide space to the outside. In the present embodiment also, the space between septum 1a and radio wave reflecting portion 2, that is, the distance between septum 1a and the inner surface of radio wave reflecting portion 2 should preferably be set, as a design value, from 0.2 mm to 0.3 mm as in Embodiment 1 above.

In the present embodiment, the side portion of slot 2b has such a shape that widens from the bottom to the opening, as shown in FIGS. 6 to 8. More specifically, four side surfaces of slot 2b are formed as planes inclined from the direction vertical to the bottom surface of trench 2b. In the present embodiment, the angle of inclination is about 1.5 degrees. Further, the space between opposing ones of the four side surfaces of slot 2b is closest on the side of the bottom surface of slot 2b, and largest on the side of radio wave reflecting surface 2a.

As the side portion of slot 2b has such a shape that widens from the bottom surface to the opening, slot 2b can easily be formed by casting technique using aluminum die cast, for example, without the necessity of cutting process. As a result, the cost necessary for forming slot 2b can significantly be reduced.

As to the shape of slot 2b with the side portion widening from the bottom portion to the opening, slot 2b may have a cross sectional shape of elliptical arc, as shown in FIG. 9. Here, when the end surface of septum 1a to be inserted to slot 2b also has a cross sectional shape of elliptical arc, contact between septum 1a and radio wave reflecting portion 2 can more easily be avoided.

In the present embodiment, such a slot 2b is formed in the radio wave reflecting surface 2a of radio wave reflecting portion 2, and a part of septum 1a of waveguide 1 is inserted to slot 2b. Therefore, at the portion of slot 2b, the gap formed by the space between septum 1a and radio wave reflecting portion 2 is not continuous as in the first prior example but disconnected, on one same plane in a direction approximately vertical to the direction of progress of the radio wave within the waveguide space. In other words, the gap detours between waveguide space A and waveguide space B, because of slot 2b and septum 1a inserted thereto.

Therefore, leakage of the radio wave between waveguide spaces A and B can more effectively reduced as compared with Embodiment 1 above, and the polarized wave separating characteristic can be improved.

In FIG. 7, there are steps provided at lower portions on both left and right sides of septum 1a. Such steps may not be provided and septum 1a as a whole may be extended. In that case, slot 2b may be extended in the left and right directions of FIG. 7 correspondingly.

Except for these points described above, the structure is the same as Embodiment 1.

The polarized wave separating characteristic of the receiving converter provided with the polarized wave separating structure in accordance with the present embodiment will be compared with that of the second prior art example.

First, the method of measurement will be described with reference to the illustrations representing the measuring system of FIGS. 10A and 10B.

Referring to FIGS. 10A and 10B, the polarized wave separating characteristic was measured using a network analyzer 10. Waveguide 11 is attached on the side of radio wave entrance side of a circularly polarized wave generator 12, and circularly polarized wave generator 12 is attached on the radio wave entrance side of receiving converter 52. An input signal is supplied through a coaxial cable 13 to waveguide 11, propagated as a linearly polarized wave through waveguide 11, and reaches circularly polarized wave generator 12. The input signal is converted to circularly polarized wave as it passes through circularly polarized wave generator. There are two types of circularly polarized wave generator 12. Namely, one that converts the input signal to d-polarized wave (d-polarized wave generator) and the one that converts the input signal to the 1-polarized wave (l-polarized wave generator).

First, using d-polarized wave generator 12, the d-polarized wave is introduced to waveguide 1 of receiving converter 52. The frequency of the input signal is continuously changed in the range of 12.2 GHz (wavelength λ=2.459 cm) to 12.7 GHz (wavelength λ=2.362 cm).

The d-polarized wave that entered the waveguide 1 is converted to linearly polarized wave by septum 1a, captured by waveguide space A, and received by radio wave receiving probe 4a. Assuming that the polarized wave separating characteristic is perfect, there is no radio wave existing in waveguide space B, and therefore, the received signal intensity of radio wave receiving probe 4b is zero. Actually, the polarized wave separating characteristic is imperfect, and therefore, there is little radio wave existing in waveguide space B, which is received by radio wave receiving probe 4b. The signal intensity (signal intensity a) received by radio wave receiving probe 4a and signal intensity (signal intensity b) received by radio wave receiving probe 4b were measured through coaxial cable 13 by network analyzer 10. The polarized wave separating characteristic was calculated in accordance with the following equation.

When the d-polarized wave is introduced to waveguide 1, the polarized wave separation characteristic is polarized wave separation characteristic=10×log (signal intensity a/signal intensity a/signal intensity b) [dBm]

Therefore, when the signal intensity b is 1/100 of signal intensity a, the polarized wave separation characteristic is 20 dBm.

Next, using d-polarized wave generator 12, the l-polarized wave is introduced to waveguide 1 of receiving converter 52. Here again, the frequency of the input signal was continuously changed in the range of 12.2 GHz (wavelength X=2.459 cm) to 12.7 GHz (wavelength λ=2.362 cm). The polarized wave separating characteristic was calculated in accordance with the following equation.

When the l-polarized wave is introduced to waveguide 1, the polarized wave separating characteristic is polarized wave separating characteristic=10×log (signal intensity b/signal intensity a) [dBm]

Referring to the graph representing the polarized wave separating characteristic of FIG. 12, first, the minimum value of the polarized wave separating characteristic over the entire range of input signal frequency was calculated when the d-polarized wave was introduced to waveguide 1 and when the l-polarized wave is introduced to waveguide 1, and smaller of the two was taken as the measurement. Practically, it is desired that the measurement value is at least 23 dBm.

Here, the value of the polarized wave separating characteristic (dBm) is measured with the distance L (mm) between the end surface of septum 1a shown in FIG. 8 and the opposing bottom surface of slot 2b of radio wave reflecting portion 2 varied, the result of which is given in the form of a table in FIG. 11 and in the form of a graph in FIG. 12. In the measurement, the distance between four side surfaces of slot 2b and septum 1a was set to 0.25 mm, and the distance between the radio wave reflecting surface 2a where slot 2b is not formed and the end surface of septum 1a was set to 0.2 mm, while the distance L between the end surface of septum 1a and the bottom surface of slot 2b of radio wave reflecting portion 2 only is changed, and the polarized wave separating characteristic was measured.

FIGS. 11 and 12 also show the results of measurement of the second prior art example, obtained through similar measurement as the present embodiment.

From the results shown in FIGS. 11 and 12, it can be understood that when the distance L between the end surface of septum 1a and the bottom surface of slot 2b of radio wave reflecting portion 2 is 1.0 mm or smaller, fully satisfactory polarized wave separating characteristic (of 23.0 dBm or higher) for practical use can be attained. Accordingly, it is understood that fully satisfactory polarized wave separating characteristic can be attained when the space between septum 1a and radio wave reflecting portion 2 is set to 1.0 mm or smaller.

From the comparison with the second prior art example, it can be understood that when the distance L between the end surface of septum 1a and the bottom surface of slot 2b of radio wave reflecting portion 2 is 0.5 mm or smaller, polarized wave separating characteristic higher than that of the second prior art example can be attained and that satisfactory polarized wave separating characteristic is realized. Accordingly, it is understood that more satisfactory polarized wave separating characteristic can be attained when the space between septum 1a and radio wave reflecting portion 2 is set to 0.5 mm or smaller. Therefore, it is preferred that the space between septum 1a and radio wave reflecting portion 2 is set to 1.0 mm or smaller and, more preferably, 0.5 mm or smaller.

The condition of the space distance is the same in Embodiment 1 above as well as in Embodiments 3 to 10, which will be described later. Namely, when the distance is set to 1.0 mm or smaller, satisfactory polarized wave separating characteristic can be attained, and when it is set to 0.5 mm or smaller, more satisfactory polarized wave separating characteristic can be attained.

Embodiment 3

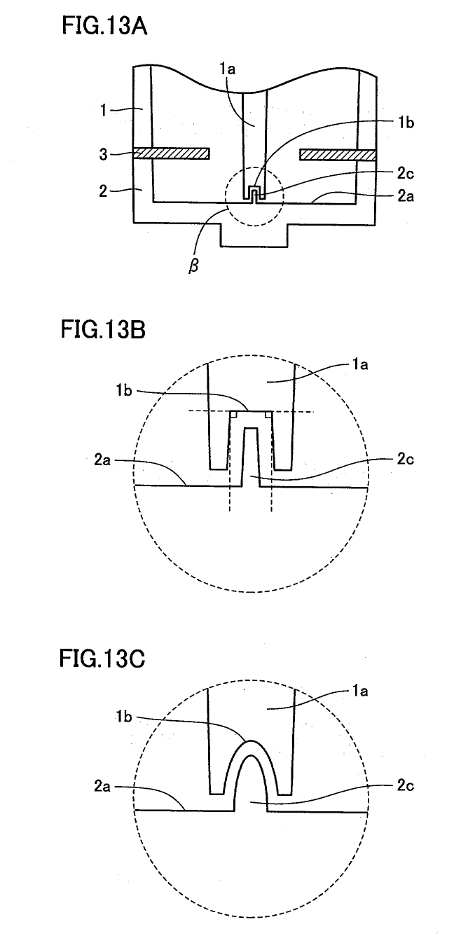

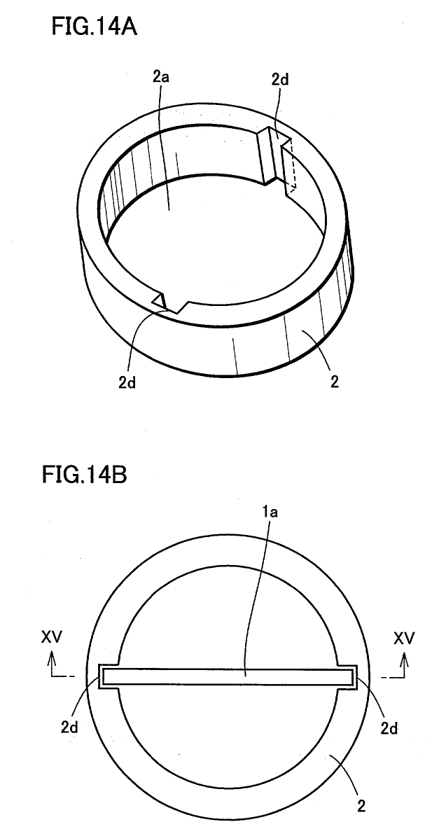

The polarized wave separating structure in accordance with Embodiment 3 of the present invention will be described with reference to FIGS. 13A to 13C.

FIG. 13A is a partial cross section showing a schematic structure of the polarized wave separating structure in accordance with the present embodiment that corresponds to FIG. 6 of Embodiment 2, and FIGS. 13B and 13C are partially enlarged views of the region β of FIG. 13A.

Embodiment 3 differs from Embodiment 1 described above mainly in that a protruded portion 2c is provided at radio wave reflecting surface 2a of radio wave reflecting portion 2, and a slot 1b is provided on the end surface of septum 1a of waveguide 1 such that protruded portion 2c is inserted thereto while radio wave reflecting portion 2 is not in contact with septum 1a.

In the present embodiment, protruded portion 2c is formed integrally with radio wave reflecting portion 2 and this can be formed as one piece by casting technique using, for example, aluminum die cast. In this embodiment also, the space between septum 1a and radio wave reflecting portion 2, that is, the distance between septum 1a and the inner surface of radio wave reflecting portion 2 should preferably be 0.2 mm to 0.3 mm as a design value, as in Embodiment 1 above.

Further, in the present embodiment, the side portion of slot 1b has such a shape that widens from the bottom portion to the opening as shown in FIG. 13B. More specifically, the side surface of slot 1b is a plane inclined from the direction vertical to the bottom surface of slot 1b. In the embodiment, the angle of inclination is set to about 1.5 degrees. Further, the space between opposing side surfaces of slot 1b is the closest on the side of the bottom surface of slot 1b and farthest at the opening of slot 1b.

As the side portion of slot 1b has such a shape that widens from the bottom surface to the opening, slot 1b can easily be formed by casting technique using aluminum die cast, for example, without the necessity of cutting process. As a result, the cost necessary for forming slot 1b can significantly be reduced.

As to the shape of slot 1b with the side portion widening from the bottom portion to the opening, slot 1b may have a cross sectional shape of elliptical arc, as shown in FIG. 13C. Here, when the end surface of protruded portion 2c of radio wave reflecting portion 2 to be inserted to slot 1b also has a cross sectional shape of elliptical arc, contact between septum 1a and radio wave reflecting portion 2 can more easily be avoided.

In the present embodiment, a protruded portion 2c is provided on the radio waver reflecting surface 2a of radio wave reflecting portion 2, and a slot 1b to which the protruded portion 2c is inserted is formed on the end surface of septum portion 1a. Therefore, at the portion of slot 1b, the gap between septum 1a and radio wave reflecting portion 2 is not continuous as in Embodiment 1 but disconnected in one plane in a direction approximately vertical to the direction of progress of the radio wave in the waveguide space. In other words, the gap detours between waveguide spaces A and B, because of the protruded portion 2c and slot 1b to which the protruded portion is inserted.

Therefore, leakage of the radio wave between waveguide spaces A and B can more effectively reduced as compared with Embodiment 1 above, and the polarized wave separating characteristic can be improved.

Except for these points, the embodiment is the same as Embodiment 1 described above.

Embodiment 4

Referring to FIGS. 14A to 16, the polarized wave separating structure in accordance with Embodiment 4 of the present invention will be described.

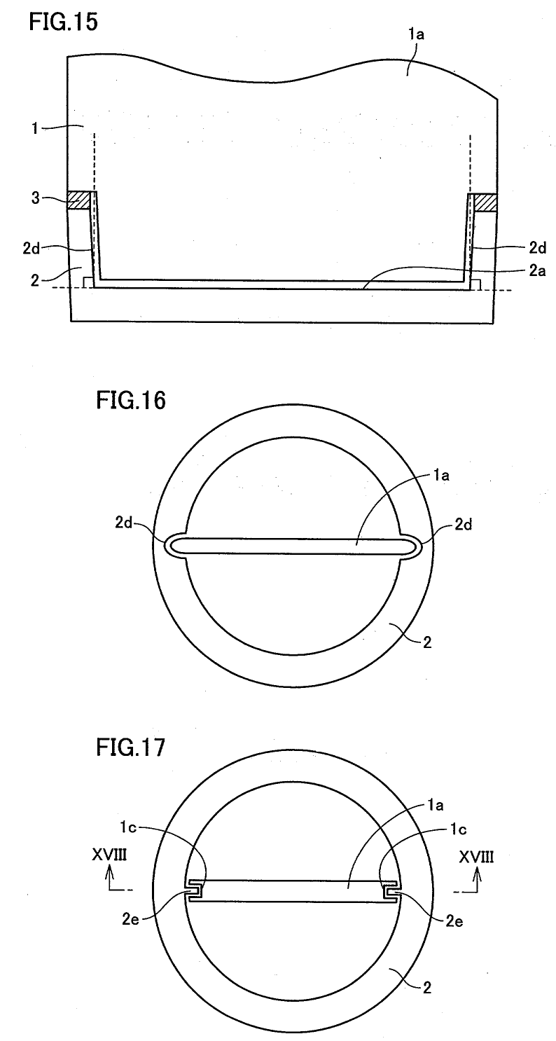

FIG. 14A is a partial perspective view representing a schematic structure of radio wave reflecting portion 2 of the present embodiment, and FIG. 14B is a cross section of the polarized wave separating structure using the radio wave reflecting portion 2, viewed from the direction of entrance of the radio wave. FIG. 15 is a partial cross section taken along the line XVXV of FIG. 14B, and FIG. 16 is a cross section of the polarized wave separating structure viewed from the direction of entrance of the radio wave, that corresponds to FIG. 14B.

Embodiment 4 differs from Embodiment 1 above mainly in that two slots 2d are provided on an inner peripheral surface of the cylindrical portion of radio wave reflecting portion 2, and opposing end surfaces of septum 1a of waveguide 1 are extended to be inserted to the slots 2d, while the radio wave reflecting portion 2 is not in contact with septum 1a. Unlike hole 102i of the second prior art example described above, slot 2d is not penetrating through the radio wave reflecting portion to expose the waveguide space to the outside. In the present embodiment also, the space between septum 1a and radio wave reflecting portion 2, that is, the distance between septum 1a and the radio wave reflecting surface 2a of radio wave reflecting portion 2 should preferably be set, as a design value, from 0.2 mm to 0.3 mm as in Embodiment 1 above.

Further, in the present embodiment, as shown in FIG. 15, the bottom portion of slot 2d has such a shape that widens from the side of radio wave reflecting surface 2a to the substrate 3. More specifically, the bottom surface of slot 2d is a plane inclined from the direction vertical to the radio wave reflecting surface 2a. In the present embodiment, the angle of inclination is about 1.5 degrees. Further, as shown in FIG. 15, the space between bottom surfaces of opposing slots 2d is closest at the side of radio wave reflecting surface 2a and farthest on the side of the substrate 3.

Though not shown, as in Embodiment 2, the side portion of slot 2d may have such a shape that widens from the bottom portion to the opening. More specifically, three side surfaces of slot 2d may be formed as planes inclined by an angle of about 1.5 degrees, for example, from the direction vertical to the bottom surface of slot 2d. As to the shape of slot 2d having the side portion widening from the bottom portion to the opening, the cross sectional shape of slot 2d may be an elliptical arc as shown in FIG. 16. When the cross sectional shape of the end surface of septum 1a to be inserted to the slot 2d is also an elliptical arc, contact between septum 1a and radio wave reflecting portion 2 can easily be avoided.

When the bottom portion of slot 2d has such a shape that widens from the side of radio wave reflecting surface 2a to the side of substrate 3, similar to the example in which the side portion of the slot has such a shape that widens from the bottom portion to the opening, slot 2d can easily be formed by casting technique using, for example, aluminum die cast, without the necessity of using cutting process. As a result, the cost necessary for forming slot 2d can significantly be reduced.

In the present embodiment, such slots 2d are formed on the inner surface of the cylindrical portion of radio wave reflecting portion 2, and parts of septum 1a of waveguide 1 are inserted to slots 2d. Therefore, at the portion of slot 2d, the space between septum 1a and radio wave reflecting portion 2 is not continuous as in Embodiment 1 above but disconnected in a curved surface along the inner surface of the cylindrical portion of radio wave reflecting portion 2. In other words, the gap detours between waveguide space A and waveguide space B, because of slot 2d and septum 1a inserted thereto.

Therefore, leakage of the radio wave between waveguide spaces A and B can more effectively reduced as compared with Embodiment 1 above, and the polarized wave separating characteristic can be improved.

Except for these points, the embodiment is the same as Embodiment 1 above. Further, in the present embodiment, the structure at radio wave reflecting surface 2a as described in Embodiment 2 or 3 may be combined, so as to further improve the polarized wave separating characteristic.

Embodiment 5

Referring to FIGS. 17 to 19, the polarized wave separating structure in accordance with Embodiment 5 of the present invention will be described.

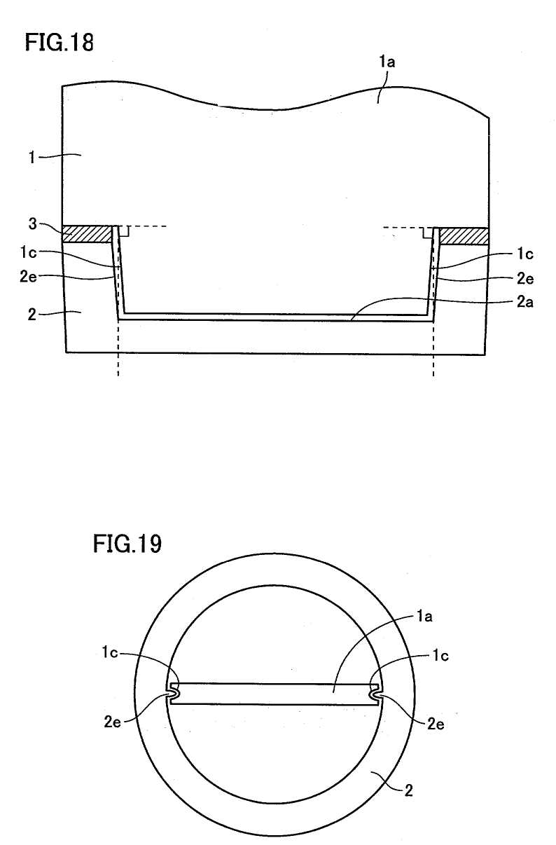

FIG. 17 is a cross section representing a schematic structure of the polarized wave separating structure in accordance with the present embodiment viewed from the direction of entrance of the radio wave, FIG. 18 is a partial cross section taken along the line XVIII-XVIII of FIG. 17, and FIG. 19 is a cross section of the polarized wave separating structure viewed from the direction of entrance of the radio wave corresponding to FIG. 17.

Embodiment 5 differs from Embodiment 1 described above mainly in that two protruded portions 2e are provided at the inner surface of cylindrical portion of radio wave reflecting portion 2, and slots 1c are provided on opposing end surfaces of septum 1a of waveguide 1 such that protruded portions 2e are inserted thereto while radio wave reflecting portion 2 is not in contact with septum 1a.

In the present embodiment, protruded portions 2e are formed integrally with radio wave reflecting portion 2 and these can be formed as one piece by casting technique using, for example, aluminum die cast. In this embodiment also, the space between septum 1a and radio wave reflecting portion 2, that is, the distance between septum 1a and the inner surface of radio wave reflecting portion 2 should preferably be 0.2 mm to 0.3 mm as a design value, as in Embodiment 1 above.

Further, in the present embodiment, as shown in FIG. 18, the bottom portion of slot 1c has such a shape that widens from the side of radio wave reflecting surface 2a to the substrate 3. More specifically, the bottom surface of slot 1c is a plane inclined from the direction vertical to the radio wave reflecting surface 2a. In the present embodiment, the angle of inclination is about 1.5 degrees. Further, as shown in FIG. 18, the space between bottom surfaces of opposing slots 1c is closest at the side of radio wave reflecting surface 2a and farthest on the side of the substrate 3.

Though not shown, as in Embodiment 3, the side portion of slot 1c may have such a shape that widens from the bottom portion to the opening. More specifically, the side surface of slot 1c may be formed as a plane inclined by an angle of about 1.5 degrees, for example, from the direction vertical to the bottom surface of slot 1c. As to the shape of slot 1c having the side portion widening from the bottom portion to the opening, the cross sectional shape of slot 1c may be an elliptical arc as shown in FIG. 19. When the cross sectional shape of the protruded portion 2e to be inserted to the slot 1c is also an elliptical arc, contact between septum 1a and radio wave reflecting portion 2 can easily be avoided.

When the bottom portion of slot 1c has such a shape that widens from the side of radio wave reflecting surface 2a to the side of substrate 3, similar to the example in which the side portion of the slot has such a shape that widens from the bottom portion to the opening, slot 1c can easily be formed by casting technique using, for example, aluminum die cast, without the necessity of using cutting process. As a result, the cost necessary for forming slot 1c can significantly be reduced.

In the present embodiment, protruded portions 2e are formed on the inner surface of the cylindrical portion of radio wave reflecting portion 2, and slots 1c to which the protruded portions 2e are inserted are formed on end surfaces of septum portion 1a. Therefore, at the portion of slot 1c, the space between septum 1a and radio wave reflecting portion 2 is not continuous as in Embodiment 1 above but disconnected in a curved surface along the inner surface of the cylindrical portion of radio wave reflecting portion 2. In other words, the gap detours between waveguide space A and waveguide space B, because of slot 1c and the protruded portion 2e inserted thereto.

Therefore, leakage of the radio wave between waveguide spaces A and B can more effectively reduced as compared with Embodiment 1 above, and the polarized wave separating characteristic can be improved. Further, in Embodiment 4 described above, a slot 2d is formed on the inner surface of the cylindrical portion of radio wave reflecting portion 2 and a part of septum 1a is extended to be inserted to the slot 2d. Therefore, it becomes necessary to change the shape of opening 3a of substrate 3 accordingly. By contrast, in the present embodiment, protruded portions 2e are formed on the inner surface of the cylindrical portion of radio wave reflecting portion 2, and slots 1c are formed on septum 1a to which the protruded portions are inserted. Therefore, it is unnecessary to change the shape of opening 3a of substrate 3.

Except for these points, the embodiment is the same as Embodiment 1 above. Further, in the present embodiment, the structure at radio wave reflecting surface 2a as described in Embodiment 2 or 3 may be combined, so as to further improve the polarized wave separating characteristic.

As an example of such a combination, Embodiments 2 and 5 may be combined.

Embodiment 6

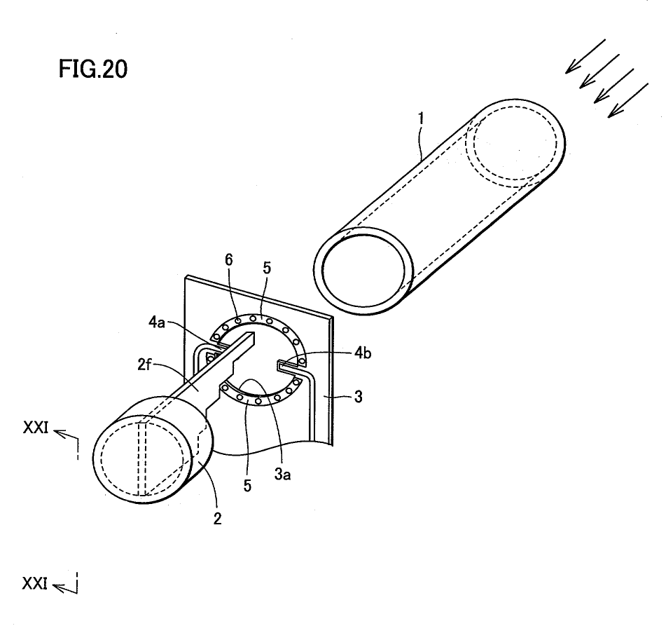

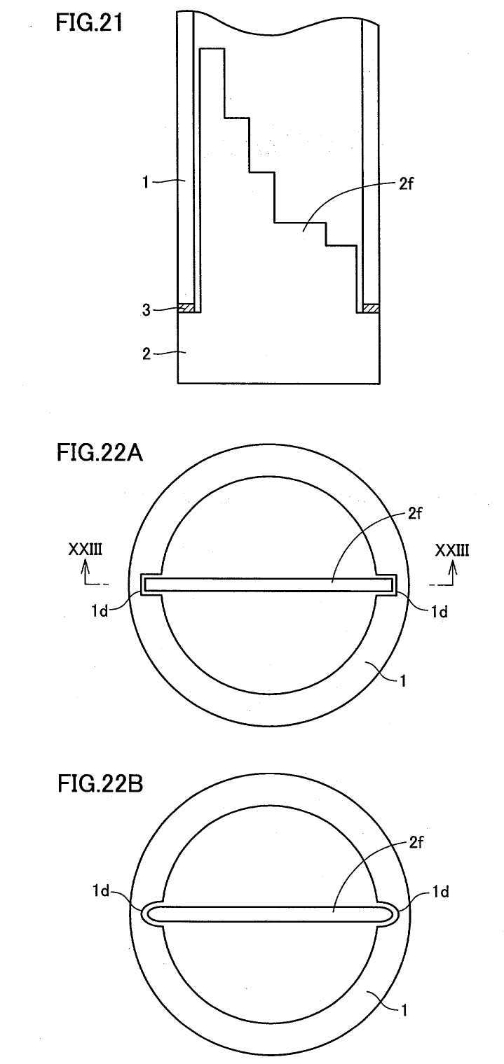

Referring to FIGS. 20 and 21, the polarized wave separating structure in accordance with Embodiment 6 of the present invention will be described.

FIG. 20 is an exploded perspective view of the main portion representing the schematic structure of the present embodiment and FIG. 21 is a partial cross section taken along the line XXXI-XXI of FIG. 20.

The present embodiment differs from Embodiment 1 in that while the septum 1a is provided inside waveguide 1 in Embodiment 1, a septum 2f is provided inside radio wave reflecting portion 2. Septum 2f extends through opening 3a to the side of waveguide 1 so as to separate respective polarized waves received by the pair of radio wave receiving probes 4a and 4b. The space between septum 2f and waveguide 1 is set such that the end surface of waveguide 1 on the side of substrate 3 is surely in contact with the grounding surface provided on one surface of substrate 3 and the end surface of radio wave reflecting portion 2 on the side of substrate 3 is surely in contact with grounding surface 5 provided on the other surface of substrate 3. In the following, differences from Embodiment 1 will be described.

In the present embodiment, waveguide 1 does not have septum 1a formed therein unlike Embodiment 1 above, and the waveguide may be formed by a casting technique using, for example, aluminum die cast.

Radio wave reflecting portion 2 of the present embodiment differs from Embodiment 1 above in that it is provided with a septum (septum portion) 2f with a stepped portion provided therein, protruding from radio wave reflecting surface 2a. Septum 2f extends through opening 3a of substrate 3 to the side of waveguide 1. In the present embodiment, radio wave reflecting portion 2 and septum 2f are formed integrally, and these two can be formed as one piece by a casting technique using, for example, aluminum die cast.

In the present embodiment, a space between septum 2f and the inner surface (inside surface) of waveguide 1 is set such that the end surface of waveguide 1 on the side of substrate 3 is surely in contact with the grounding surface provided on one surface of substrate 3 and the end surface of radio wave reflecting portion 2 on the side of substrate 3 is surely in contact with grounding surface. 5 provided on the other surface of substrate 3, while septum 2f is not in contact with waveguide 1.

More specifically, in the present embodiment, a structure is provided in which the end surface of waveguide 1 on the side of the substrate 3 is in tight contact without any gap with and along the grounding surface provided on one surface of substrate 3 and the end surface of radio wave reflecting portion 2 on the side of substrate 3 is in tight contact without any gap with and along the grounding surface 5 provided on the other surface of substrate 3, thereby radio wave does not leak to the outside and any noise component does not enter from the outside, at the contact portion between the end surface of waveguide 1 on the side of substrate 3 and the grounding surface provided on one surface of substrate 3 and at the contact portion between the end surface of radio wave reflecting portion 2 on the side of substrate 3 and grounding surface 5 provided on the other surface of substrate 3.

In the present embodiment, septum 2a is provided not in contact with the inner surface of opening 3a, so that the end surface of waveguide 1 on the side of substrate 3 is surely in contact with the grounding surface provided on one surface of substrate 3 and the end surface of radio wave receiving portion 2 on the side of substrate 3 is surely in contact with grounding surface 5 provided on the other surface of substrate 3.

More specifically, as shown in FIG. 21, the end surface of septum 2f is not in contact with the inner surface (inside surface) of waveguide 1. Further, as shown in FIG. 21, the end surface of septum 2f is not in contact with the inner surface (inside surface) of opening 3a of substrate 3, either. Generally, such a radio wave receiving converter has the inside made airtight. Therefore, between septum 2f and waveguide 1 and between septum 2f and opening 3a, there is no separate member interposed, but gas, such as air, exists only.

By this embodiment also, similar to Embodiment 1 above, leakage of the radio wave to the outside of the waveguide space or increase of noise can be suppressed while fully satisfactory polarized wave separating characteristic is maintained. Further, unlike the second prior art example described above, a separate member for connecting the waveguide and the radio wave reflecting portion is unnecessary, and the structure is simple. Therefore, it is suitable for mass production and facilitates manufacture, and the ratio of satisfactory products of mass production can be improved.

In the present embodiment, similar to Embodiment 1, the space between septum 2f and waveguide 1, that is, the distance between septum 2f and the inner surface of waveguide 1 should preferable be set to 0.2 mm to 0.3 mm as a design value. Here, the space refers to the space between the end surface of septum 2f extending linearly from the position where the substrate 3 is arranged at the cross section of FIG. 21 and not the stepped portion of septum 2f, on the left side of FIG. 21, and the opposing inner surface of waveguide 1.

Embodiment 7

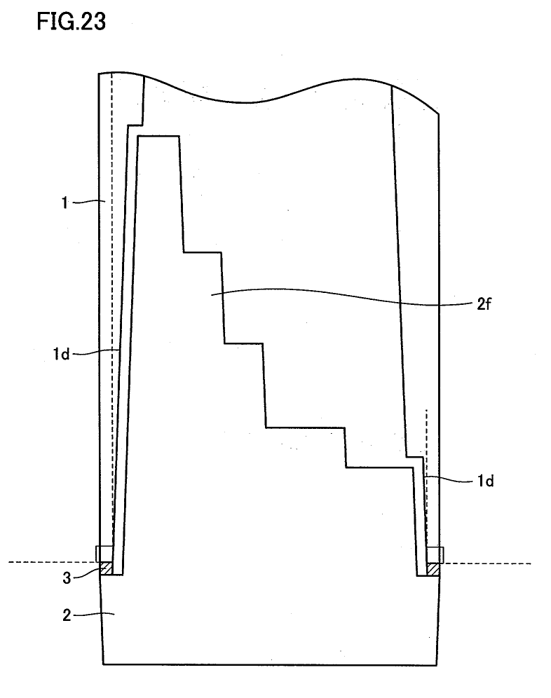

Referring to FIGS. 22A to 23, the polarized wave separating structure in accordance with Embodiment 7 of the present invention will be described.

FIGS. 22A and 22B are cross sections representing the schematic structure of the polarized wave separating structure in accordance with the present embodiment viewed from the direction of entrance of the radio wave, and FIG. 23 is a partial cross section taken along the line XXIII-XXIII of FIG. 22A.

Embodiment 7 differs from Embodiment 6 above mainly in that two slots 1d are provided on the inner surface of waveguide 1, and opposing end surface of septum 2f of radio wave reflecting portion 2 are extended to be inserted to slots 1d, while waveguide 1 and septum 2f are not in contact with each other. Slot 1d is not penetrating through the waveguide 1 to expose the waveguide space to the outside. In the present embodiment also, the space between septum 2f and waveguide 1, that is, the distance between septum 2f and the inner surface of waveguide 1 should preferably be set, as a design value, from 0.2 mm to 0.3 mm as in Embodiment 6 above.

Further, in the present embodiment, as shown in FIG. 23, the bottom portion of slot 1d has such a shape that widens from the radio wave entrance side to the substrate 3. More specifically, the bottom surface of slot 1d is a plane inclined from the direction vertical to the substrate surface of substrate 3. In the present embodiment, the angle of inclination is about 1.5 degrees. Further, as shown in FIG. 23, the space between bottom surfaces of opposing slots 1d is closest at the radio wave entrance side and farthest on the side of the substrate 3.

Though not shown, as in Embodiment 2, the side portion of slot 1d may have such a shape that widens from the bottom portion to the opening. More specifically, side surfaces of slot 1d may be formed as planes inclined by an angle of about 1.5 degrees, for example, from the direction vertical to the bottom surface of slot 1d. As to the shape of slot 1d having the side portion widening from the bottom portion to the opening, the cross sectional shape of slot 1d may be an elliptical arc as shown in FIG. 22B. When the shape of the end surface of septum 2f to be inserted to the slot 1d is also an elliptical arc, contact between septum 2f and waveguide 1 can easily be avoided.

When the bottom portion of slot 1d has such a shape that widens from the radio wave entrance side to the side of substrate 3, similar to the example in which the side portion of the slot has such a shape that widens from the bottom portion to the opening, slot 1d can easily be formed by casting technique using, for example, aluminum die cast, without the necessity of using cutting process. As a result, the cost necessary for forming slot 1d can significantly be reduced.

In the present embodiment, such slots 1d are formed on the inner surface of the waveguide 1, and parts of septum 2f of radio wave reflecting portion 2 are inserted to slots 1d. Therefore, at the portion of slot id, the space between septum 2f and waveguide 1 is not continuous as in Embodiment 6 above but disconnected in a curved surface along the inner surface of the waveguide 1. In other words, the gap detours between waveguide space A and waveguide space B, because of slot 1d and septum 2f inserted thereto.

Therefore, leakage of the radio wave between waveguide spaces A and B can more effectively reduced as compared with Embodiment 6 above, and the polarized wave separating characteristic can be improved.

Except for these points, the embodiment is the same as Embodiment 6 above.

Embodiment 8

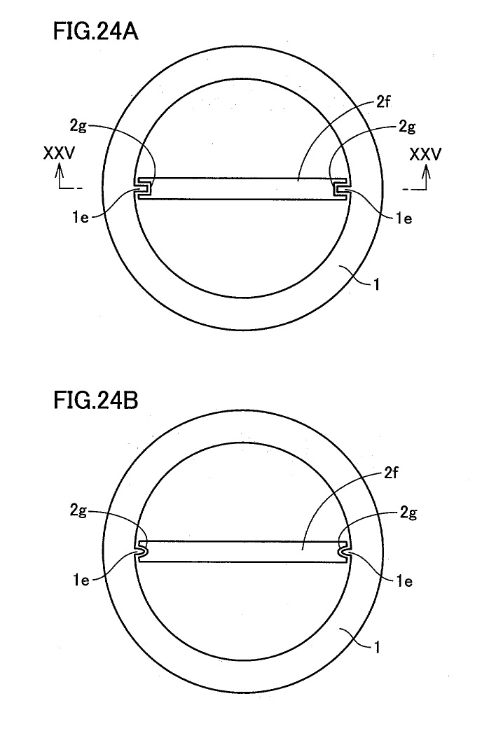

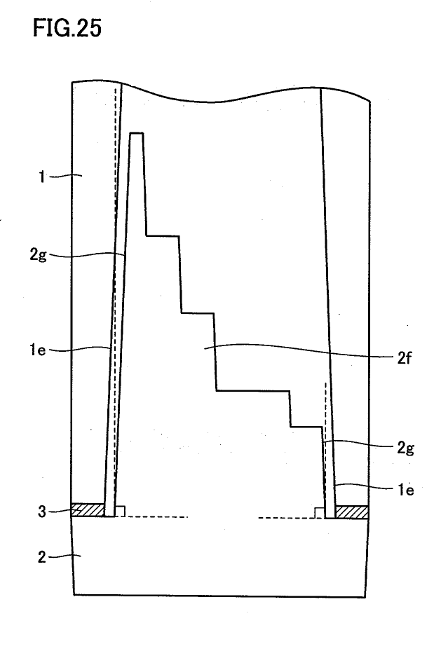

Referring to FIGS. 24A to 25, the polarized wave separating structure in accordance with Embodiment 8 of the present invention will be described.

FIGS. 24A and 24B are cross sections representing schematic structure of the polarized wave separating structure in accordance with the present embodiment, viewed from the direction of entrance of the radio wave, and FIG. 25 is a partial cross section taken along the line XXXV-XXXV of FIG. 24A.

Embodiment 8 differs from Embodiment 6 described above mainly in that two protruded portions le are provided on the inner surface of waveguide 1, and slots 2g are provided on opposing end surfaces of septum 2f of radio wave reflecting portion 2 to which the protruded portions 1e are inserted, while waveguide 1 and septum 2f are not in contact with each other.

In the present embodiment, protruded portions 1e are formed integrally with waveguide 1 and these can be formed as one piece by casting technique using, for example, aluminum die cast. In this embodiment also, the space between septum 2f and waveguide 1, that is, the distance between septum 2f and the inner surface of waveguide 1 should preferably be 0.2 mm to 0.3 mm as a design value, as in Embodiment 6 above.

Further, in the present embodiment, as shown in FIG. 25, the bottom portion of slot 2g has such a shape that widens from the radio wave entrance side to the substrate 3. More specifically, the bottom surface of slot 2g is a plane inclined from the direction vertical to the substrate surface of substrate 3. In the present embodiment, the angle of inclination is about 1.5 degrees. Further, as shown in FIG. 25, the space between bottom surfaces of opposing slots 2g is closest at the radio wave entrance side and farthest on the side of the substrate 3.

Though not shown, as in Embodiment 3, the side portion of slot 2g may have such a shape that widens from the bottom portion to the opening. More specifically, side surfaces of slot 2g may be formed as planes inclined by an angle of about 1.5 degrees, for example, from the direction vertical to the bottom surface of slot 2g. As to the shape of slot 2g having the side portion widening from the bottom portion to the opening, the cross sectional shape of slot 2g may be an elliptical arc as shown in FIG. 24B. When the cross sectional shape of the protruded portion 1e to be inserted to the slot 2g is also an elliptical arc, contact between septum 2f and waveguide 1can easily be avoided.

When the bottom portion of slot 2g has such a shape that widens from the radio wave entrance side to the side of substrate 3, similar to the example in which the side portion of the slot has such a shape that widens from the bottom portion to the opening, slot 2g can easily be formed by casting technique using, for example, aluminum die cast, without the necessity of using cutting process. As a result, the cost necessary for forming slot 2g can significantly be reduced.

In this manner, in the present embodiment, protruded portions le are formed on the inner surface of waveguide 1, and slots 2g, to which the protruded portions le are inserted, are formed on end surfaces of septum portion 2f. Therefore, at the portion of slot 2g, the space between septum 2f and waveguide 1 is not continuous as in Embodiment 6 above but disconnected in a curved surface along the inner surface of the waveguide 1. In other words, the gap detours between waveguide space A and waveguide space B, because of slot 2g and the protruded portion 1e inserted thereto.

Therefore, leakage of the radio wave between waveguide spaces A and B can more effectively reduced as compared with Embodiment 6 above, and the polarized wave separating characteristic can be improved.

Except for these points, the embodiment is the same as Embodiment 6 described above.

Embodiment 9

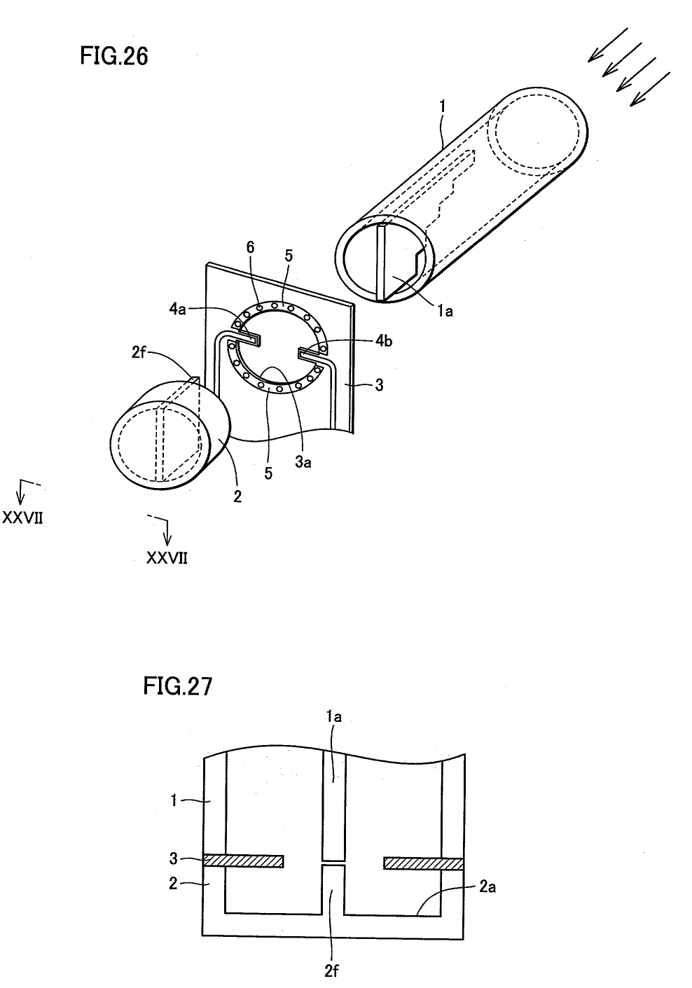

Referring to FIGS. 26 and 27, the polarized wave separating structure in accordance with Embodiment 9 of the present invention will be described.

FIG. 26 is an exploded perspective view of the main portion representing a schematic structure of the present embodiment, and FIG. 27 is a partial cross section taken along the line XXXVII-XXXVII of FIG. 26.

In contrast to Embodiment 1 in which septum 1a is provided only in waveguide 1 and Embodiment 6 in which septum 2f is provided only in radio wave reflecting portion 2, in the present embodiment, septum 1a is provided in waveguide 1, and septum 2f is provided in radio wave reflecting portion 2. The two septums 1a and 2f are arranged opposed to each other to separate respective polarized waves received by the pair of radio wave receiving portions 4a and 4b. The space between the septums 1a and 2f is set such that the end surface of waveguide 1 on the side of substrate 3 is surely in contact with the grounding surface provided on one surface of substrate 3 and the end surface of radio wave reflecting portion 2 on the side of substrate 3 is surely in contact with the grounding surface 5 provided on the other surface of substrate 3. In the following, differences from Embodiment 1 will be described.

In waveguide 1 of the present embodiment, septum 1a with a stepped portion is formed inside, which is not so much extended as compared with the one of Embodiment 1. In the present embodiment, waveguide 1 and septum 1a are formed integrally as in Embodiment 1, and these can be formed as one piece by a casting technique using, for example, aluminum die cast.

The radio wave reflecting portion 2 of the present embodiment has a septum 2f formed therein, protruding from the radio wave reflecting surface. However, the septum is not so much extended as compared with the one of Embodiment 6 described above, and septum 2f is not provided with the stepped portion. In the present embodiment, as in Embodiment 6, radio wave reflecting portion 2 and septum 2f are formed integrally, and these can be formed as one piece by a casting technique using, for example, aluminum die cast.

In the present embodiment, referring to FIG. 27, the end surface of septum 1a is arranged opposed to the end surface of septum 2f, near the opening 3a of substrate 3. Further, a space between septums 1a and 2f is set such that the end surface of waveguide 1 on the side of substrate 3 is surely in contact with the grounding surface provided on one surface of substrate 3 and the end surface of radio wave reflecting portion 2 on the side of substrate 3 is surely in contact with grounding surface 5 provided on the other surface of substrate 3, while septums 1a and 2f are not in contact with each other.

More specifically, in the present embodiment, a structure is provided in which the end surface of waveguide 1 on the side of the substrate 3 is in tight contact without any gap with and along the grounding surface provided on one surface of substrate 3 and the end surface of radio wave reflecting portion 2 on the side of substrate 3 is in tight contact without any gap with and along the grounding surface 5 provided on the other surface of substrate 3, thereby radio wave does not leak to the outside and any noise component does not enter from the outside, at the contact portion between the end surface of waveguide 1 on the side of substrate 3 and the grounding surface provided on one surface of substrate 3 and at the contact portion between the end surface of radio wave reflecting portion 2 on the side of substrate 3 and grounding surface 5 provided on the other surface of substrate 3.

In the present embodiment, septums 1a and 2f are provided not in contact with the inner surface of opening 3a, so that the end surface of waveguide 1 on the side of substrate 3 is surely in contact with the grounding surface provided on one surface of substrate 3 and the end surface of radio wave receiving portion 2 on the side of substrate 3 is surely in contact with grounding surface 5 provided on the other surface of substrate 3.

More specifically, referring to FIG. 27, the end surface of septum 1a and the end surface of septum 2f opposing to each other do not contact with each other. Further, end surfaces of septums 1a and 2f are not in contact with the inner surface (inside surface) of the opening 3a of substrate 3. Generally, such a radio wave receiving converter has the inside made airtight. Therefore, between septums 1a and 2f and between septum 1a or 2f and opening 3a, there is no separate member interposed, but gas, such as air, exists only.

By this embodiment also, similar to Embodiments 1 and 6 above, leakage of the radio wave to the outside of the waveguide space or increase of noise can be suppressed while fully satisfactory polarized wave separating characteristic is maintained. Further, unlike the second prior art example described above, a separate member for connecting the waveguide and the radio wave reflecting portion is unnecessary, and the structure is simple. Therefore, it is suitable for mass production and facilitates manufacture, and the ratio of satisfactory products of mass production can be improved.

Further, the present invention has such a structure that both septums 1a and 2f do not penetrate through opening 3a of substrate 3, as shown in FIG. 27, and septums 1a and 2f are extended to the position of the end surfaces on the side of substrate 3 of the cylindrical portions of waveguide 1 and radio wave reflecting portion 2, respectively. In this respect, in Embodiment 1 described above, there is a gap between septum 1a and the inner surface of cylindrical portion of radio wave reflecting portion 2 as shown in FIG. 4, and in Embodiment 6, there is a gap between septum 2f and the inner surface of the cylindrical portion of waveguide 1 as shown in FIG. 21. Therefore, in the structure of the present embodiment, there is no gap formed between the septum and the inner surface of the cylindrical portion of the waveguide 1 or the inner surface of the cylindrical portion of radio wave reflecting portion 2 as in Embodiment 1 or 6 above, and hence the polarized wave separating characteristic can further be improved.

In the present embodiment, similar to Embodiments 1 and 6 described above, the space between septums 1a and 2f, that is, the distance between opposing end surfaces of septums 1a and 2f should preferably be 0.2 mm to 0.3 mm as a design value.

Embodiment 10

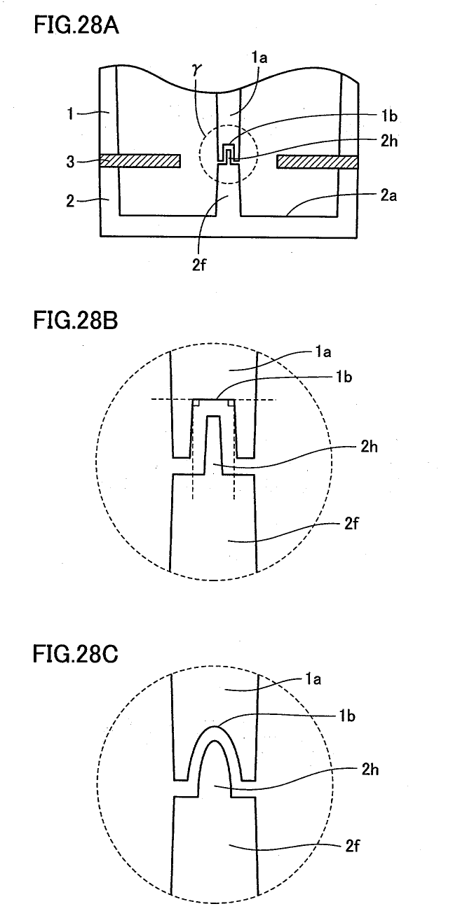

Referring to FIGS. 28A to 28C, the polarized wave separating structure in accordance with Embodiment 10 of the present invention will be described.

FIG. 28A is a partial vertical section representing a schematic structure of the polarized wave separating structure of the present embodiment that corresponds to FIG. 27, and FIGS. 28B and 28C are partial enlarged cross sections of the region γ of FIG. 28A.

Embodiment 10 differs from Embodiment 9 described above mainly in that a protruded portion 2h is provided at an end surface of septum 2f of radio wave reflecting portion 2, and a slot 1b is formed on the end surface of septum 1a of waveguide 1, to which the protruded portion 2h is inserted, while septums 2f and 1a are not in contact with each other.

In the present embodiment, protruded portion 2h is formed, together with septum 2f, integrally with radio wave reflecting portion 2 and these can be formed as one piece by casting technique using, for example, aluminum die cast. In this embodiment also, the space between septums 1a and 2f, that is, the distance between opposing surfaces of septums 1a and 2f should preferably be 0.2 mm to 0.3 mm as a design value, as in Embodiment 9 above.

Further, in the present embodiment, the side portion of slot 1b has such a shape that widens from the bottom portion to the opening as shown in FIG. 28B. More specifically, the side surface of slot 1b is a plane inclined from the direction vertical to the bottom surface of slot 1b. In the embodiment, the angle of inclination is set to about 1.5 degrees. Further, the space between opposing side surfaces of slot 1b is the closest on the side of the bottom surface of slot 1b and farthest on the side of radio wave reflecting surface 2a.

As to the shape of slot 1b with the side portion widening from the bottom portion to the opening, slot 1b may have a cross sectional shape of elliptical arc, as shown in FIG. 28C. Here, when the end surface of protruded portion 2h to be inserted to slot 1b also has a cross sectional shape of an elliptical arc, contact between septums 1a and 2f can more easily be avoided.

As the side portion of slot 1b has such a shape that widens from the bottom surface to the opening, slot 1b can easily be formed by casting technique using aluminum die cast, for example, without the necessity of cutting process. As a result, the cost necessary for forming slot 1b can significantly be reduced.

Here, a protruded portion may be provided on the end surface of septum 1a of waveguide 1, a slot may be formed on the end surface of septum 2f of radio wave reflecting portion 2 to which the protruded portion is inserted, and the side portion of the slot may have a shape that widens from the bottom portion to the opening.

In the present embodiment, a protruded portion is formed on one of the opposing end surfaces of septum 1a of waveguide 1 and septum 2f of radio wave reflecting portion 2, and a slot for inserting the protruded portion is formed on the other end surface. Therefore, at the portion of the slot, the space between septums 1a and 2f is not continuous as in Embodiment 9 above but disconnected in the same plane that is approximately vertical to the direction of progress of the radio wave in the waveguide space. In other words, the gap detours between waveguide space A and waveguide space B, because of the slot and the protruded portion inserted thereto.

Therefore, leakage of the radio wave between waveguide spaces A and B can more effectively reduced as compared with Embodiment 9 above, and the polarized wave separating characteristic can be improved.

Except for these points, the present embodiment is the same as Embodiment 9 described above.

Embodiment 11

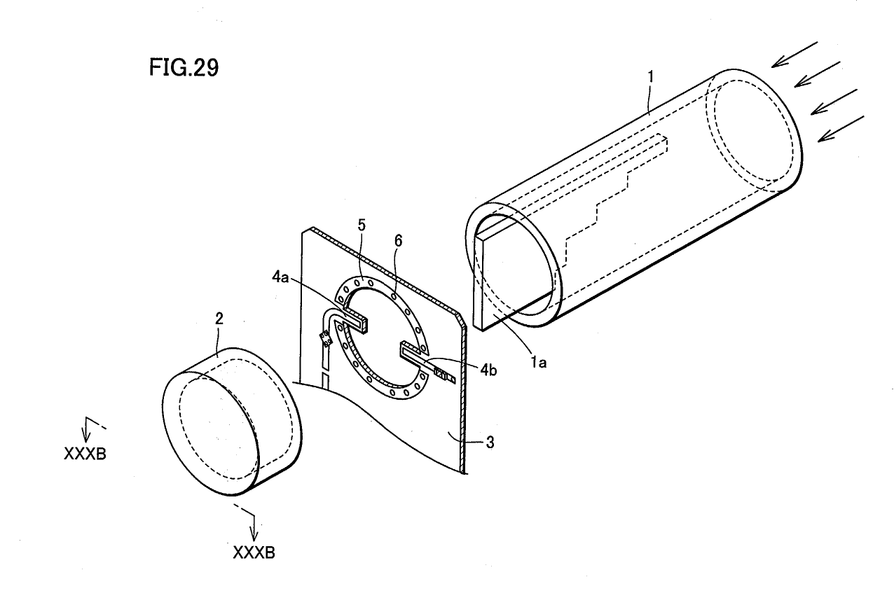

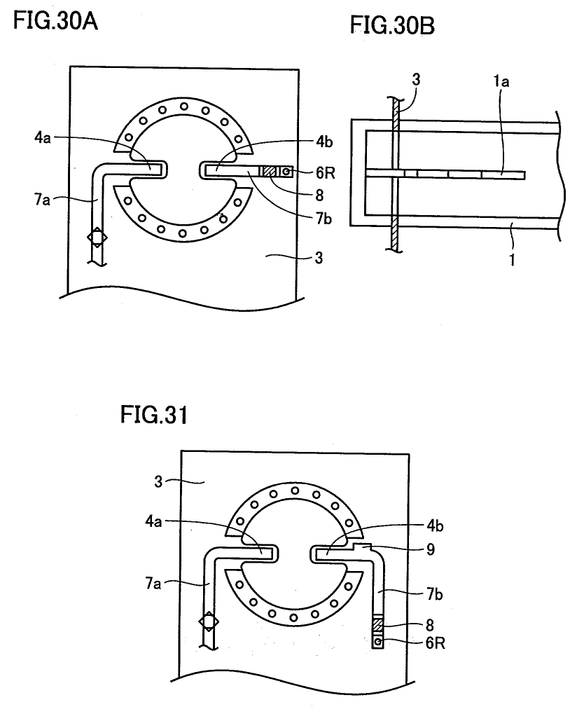

Referring to FIGS. 29 and 30B, the polarized wave separating structure in accordance with Embodiment 11 will be described.

In the embodiments above, the radio wave receiving probe 4b must be terminated with a terminating resistance, in order to attenuate polarized wave that is not to be received by radio wave receiving probe 4b. For this purpose, a terminating resistance is used. A general terminating resistance, however, cannot sufficiently attenuate the polarized wave that is not to be received. Therefore, an expensive resistance with frequency characteristic compensated for microwave becomes necessary, resulting in higher cost.

Further, the polarized wave that is not to be received is once to receive by radio wave receiving probe 4b and guided to substrate 3. Therefore, when there is a mismatching at the terminating circuit for attenuation, the polarized wave goes over substrate 3 as a reflected wave and when this reflected wave happens to reach the probe 4a of the receiving side, the polarized wave that should not be received would be received, resulting in lower degree of discrimination (lower degree of cross polarization discrimination). An embodiment to solve this problem will be described in the following.

FIG. 29 is an exploded perspective view of a main portion representing a schematic structure of the present embodiment, FIG. 30A is a top view of the substrate, and FIG. 30B is a cross section taken along the line XXXB-XXXB of FIG. 29.

In FIG. 29, the polarized wave separating structure is the same as that of FIG. 2, and a reflection free terminating portion is formed for absorbing received polarized wave, on one of the pair of radio wave receiving portions 4a, 4b formed on substrate 3. Namely, referring to FIG. 30A, a resistor 8 for termination is arranged on the side of microstrip line 7b on the end of the substrate, from radio wave receiving probe 4b, and the other end of resistor 8 is connected to the grounding surface on the opposite side of substrate 3, via through hole 6R.

The d-polarized wave introduced to waveguide 1 is converted to a linearly polarized wave by the stepped septum 1a in waveguide 1, received by radio wave receiving probe 4a, transmitted to the converter circuit of the succeeding stage to be amplified with low noise, further converted to an intermediate frequency, and output to a BS receiver, for example.

The l-polarized wave is converted to a linearly polarized wave by the stepped septum 1a, received by radio wave receiving probe 4b, passed through microstrip line 7b, transmitted through resistor 8 and through hole 6R to the reflection free terminating circuit that is grounded, and is attenuated. Thus, unnecessary polarized wave can be absorbed, and degradation of discrimination can be avoided. Further, as the resistor 8 can be arranged near the radio wave receiving probe 4b, an expensive resistance with the frequency characteristic compensated for microwave is unnecessary, and matching can be attained by a general resistor. Thus, unnecessary polarized wave can sufficiently be attenuated while not increasing the cost.

Embodiment 12

Referring to FIG. 31, the polarized wave separating structure in accordance with Embodiment 12 of the present invention will be described.

FIG. 31 is a top view of the substrate of the polarized wave separator. Referring to FIG. 31, the polarized wave separating structure is the same as that of the embodiments described above, except that a stub matching portion 9 is provided on microstrip line 7b of substrate 3, and that the microstrip line 7b is bent downward at about 90°. As stub matching portion 9 realizes satisfactory adjustment of impedance matching with the reflection free terminating circuit of the succeeding stage, generation of the reflected wave can be suppressed. Further, even when the resistor 8 is an inexpensive general resistor 8, matching can be attained by stub matching portion 9. Therefore, the cost can be reduced.

Embodiment 13

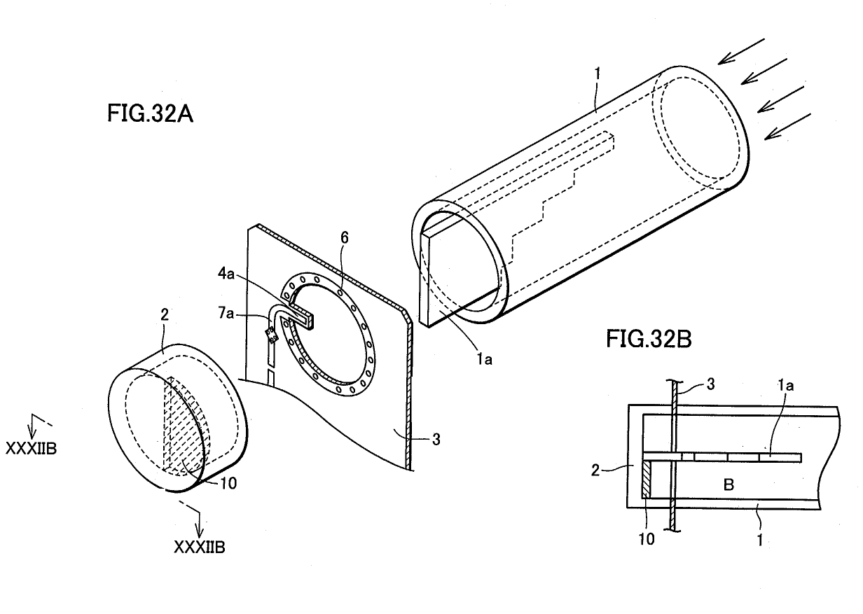

FIG. 32A is an exploded perspective view of a main portion representing the polarized wave separating structure in accordance with Embodiment 13 of the present invention, and FIG. 32 is a cross section taken along the line XXXIIB-XXXIIB of FIG. 32A.

Referring to FIG. 32A, the basic structure of the polarized wave separating structure is the same as that of FIG. 2. The radio wave receiving probe 4b, however, is omitted, and on the reflecting surface on the side of waveguide space B inside the radio wave reflection portion 2, a reflection free terminating portion 10 such as a radio wave absorber is provided. As reflection free terminating portion 10, one prepared by mixing magnetic powder such as ferrite in rubber based material such as silicone rubber, to provide the radio wave absorbing function, may be used.

Operation is as follows. The l-polarized wave is converted to the linearly polarized wave by the stepped septum 1a and guided to waveguide space B. The wave, however, is not received, as there is no radio wave receiving probe 4b, but introduced to radio wave reflecting portion 2. Here, reflection free terminating portion 10 is provided at radio wave reflecting portion 2. Therefore, the l-polarized wave that has been converted to linearly polarized wave is attenuated here. Therefore, leakage of the l-polarized wave component to the substrate 3, or the wave going over as the reflected wave can be suppressed.

Embodiment 14

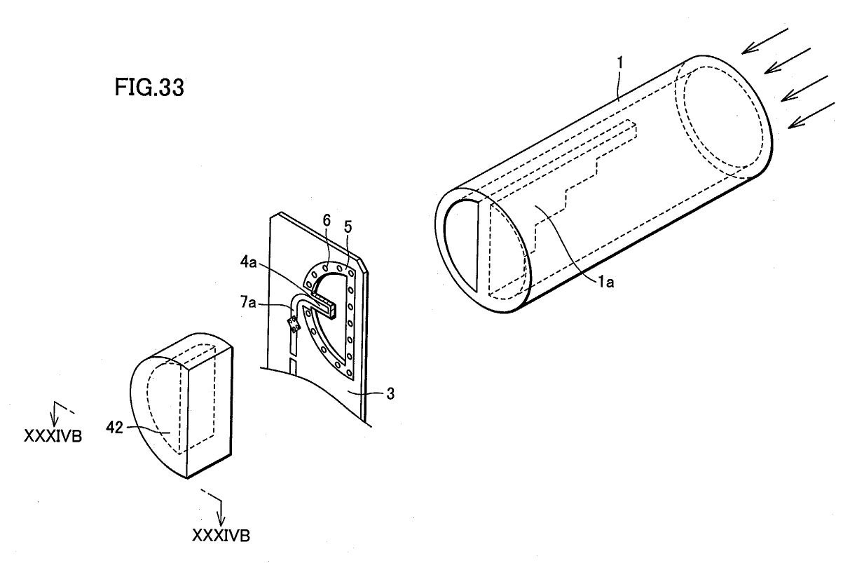

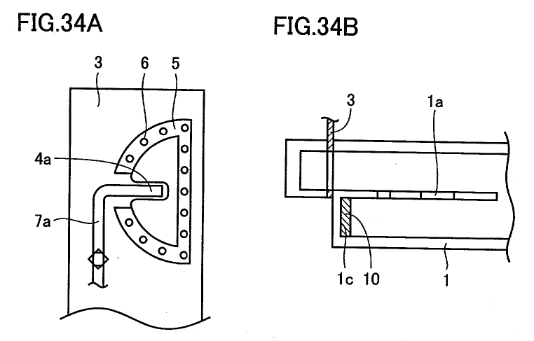

FIG. 33 is an exploded perspective view of a main portion representing the polarized wave separating structure in accordance with Embodiment 14 of the present invention, FIG. 34A is a top view of the substrate, and FIG. 34B is a cross section taken along the line XXXIVB-XXXIVB of FIG. 33.

In Embodiment 14, one semicircular portion of waveguide 1 separated by septum 1a is closed to provide reflecting surface 1f, while the other semicircular portion is opened. Further, the opening of substrate 3 is adapted to correspond to the semicircular opening of waveguide 1. Further, only one radio wave receiving probe 4a is provided on substrate 3. As shown in FIG. 34B, at the radio wave reflecting portion, reflection free terminating portion 10 is attached to reflecting surface 1c of waveguide 1.

The operation is as follows. Similar to the description above, of the received polarized waves, the d-polarized wave is received by receiving probe 4a, as waveguide space A is formed by septum 1a, the semiconductor circular opening surface of substrate 3 and radio wave reflecting portion 42. The l-polarized wave is separated by septum 1a. The wave however, is not transmitted to substrate 3 as waveguide 1 is closed, but is reflected at reflecting surface 1f As the reflection free terminating portion 10 is provided on reflecting surface 1f, the l-polarized wave is absorbed and attenuated. Thus, only the d-polarized wave is received.

In the present embodiment, as the waveguide space B is not formed and the receiving probe 4b is not provided, the unnecessary l-polarized wave does no go over substrate 3, and hence higher degree of separation is expected. Further, as the l-polarized wave entering waveguide 1 is attenuated by reflection free terminating portion 10 such as the radio wave absorber, better performance is expected. Further, as the shape of substrate 3 can be made smaller, the overall device can be made smaller, which is preferable in view of cost.

Embodiment 15

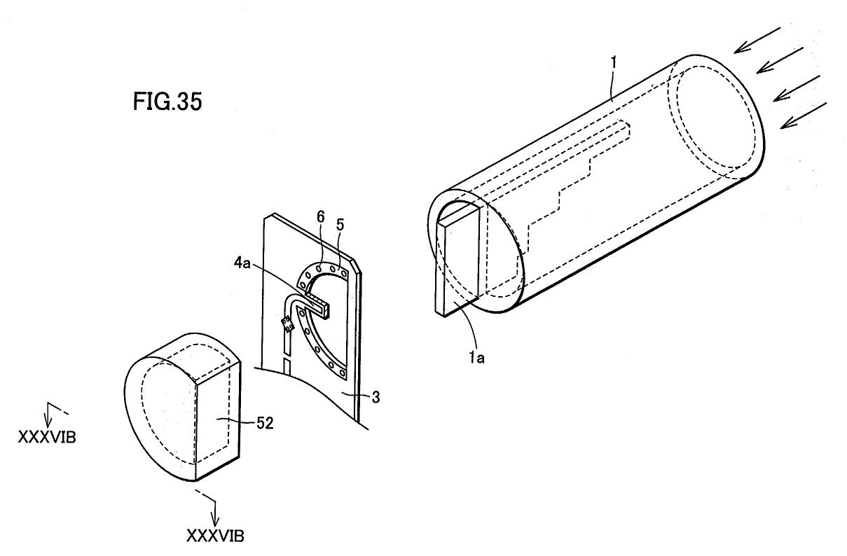

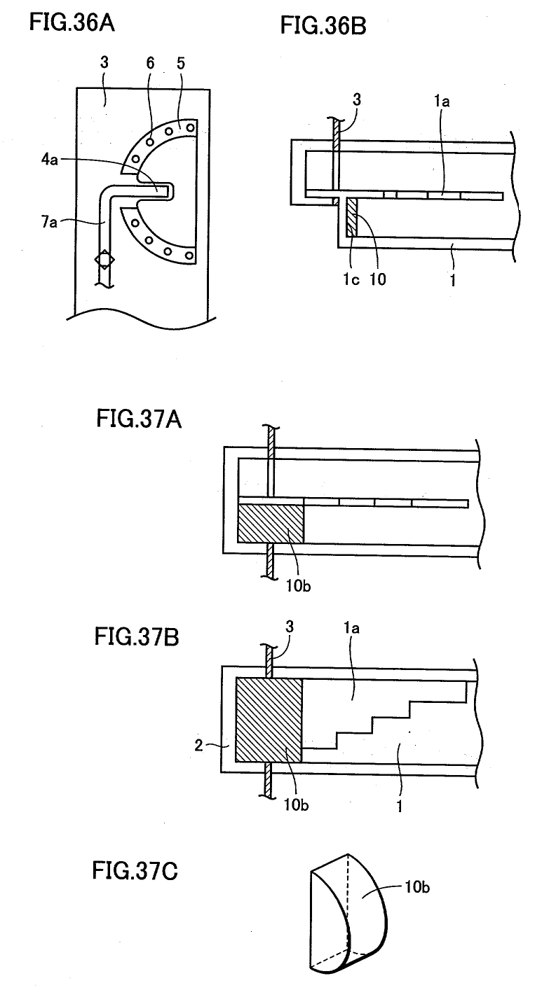

FIG. 35 is an exploded perspective view of a main portion representing a polarized wave separating structure in accordance with Embodiment 15 of the present invention, FIG. 36A is a top view of the substrate, and FIG. 36B is a cross section taken along the line XXXVIB-XXXVIB of FIG. 35.

The embodiment is the same both in structure and operation as that of FIGS. 34, 34B and 35, except that the septum 1a of waveguide 1 is extended to the reflecting surface of radio wave reflecting portion 52. Though the shape of the opening of substrate 3 and radio wave reflecting portion 52 will be slightly larger than that in Embodiment 14 as the cross sectional shape of septum 1a must be covered, grounding can be attained with higher reliability, and therefore, higher degree of separation is attained.

Modifications of the reflection free terminating portions of Embodiments 13 to 15 will be described. As already described, a radio wave absorber prepared by mixing magnetic powder such as ferrite in rubber material such as silicone rubber to provide the radio wave absorbing function is used. The amount of absorption, however, is not very large, and therefore it is difficult to provide a satisfactory reflection free terminating portion 10.

Therefore, a reflection free terminating portion is formed as shown in FIGS. 37 to 40.

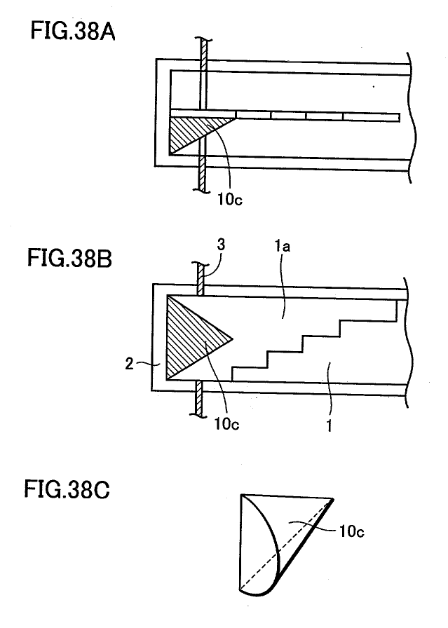

FIGS. 37A to 40A are horizontal cross sections of the waveguide, FIGS. 37B to 40B are vertical cross sections of the same, FIG. 37C represents a columner radio wave absorber, and FIG. 38C represents a conical radio wave absorber.

As the reflection free terminating portion 10, a columner radio wave absorber 10b of a semi-columner shape may be formed by impregnating a polystyrol based foam, for example, with carbon and covering the waveguide space therewith as shown in FIG. 37C, to increase the amount of attenuation.

When a conical radio wave absorber 10c is used as shown in FIG. 38C, better matching is attained when the polarized wave enters from the space to the radio wave absorber, and hence reflection wave can be reduced.

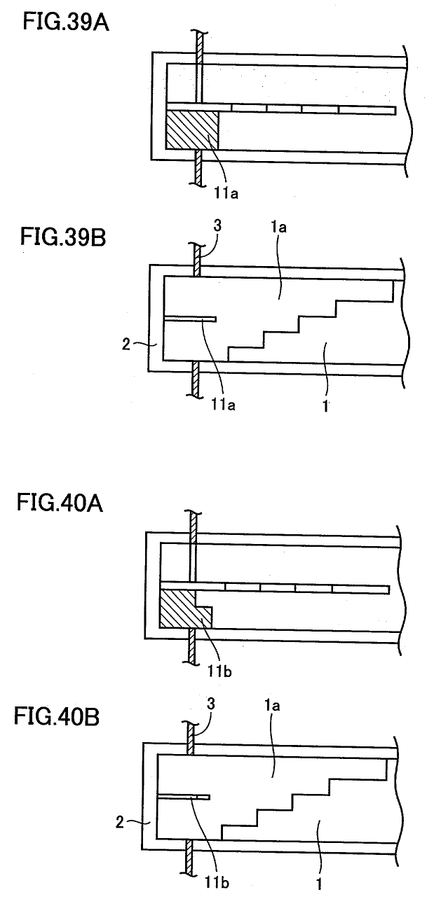

FIGS. 39A, 39B, 40A and 40B represent examples using resistance plates. A resistance plate 11A shown in FIGS. 39A and 39B is a resin plate prepared by applying carbon coating on a surface of a thin resin of vinyl chloride or PET so as to attain the resistance value per 10 mm×10 mm square of several tens to several hundreds Ω, which is used for absorbing radio wave that is parallel to the resistance plate 11a. When the resistance plate 11a is inserted in a direction crossing the septum 1a in waveguide 1, unnecessary l-polarized wave can be absorbed.

Further, as shown in FIGS. 40A and 40B, a cutout portion may be formed at one end of resistance plate 11b on the side of septum 1a of waveguide 1a at the opening side, so as to attain matching when the polarized wave enters from the space to the resistance plate 11b and to suppress the reflection wave generated there. Thus, more satisfactory reflection free terminating portion can be formed.

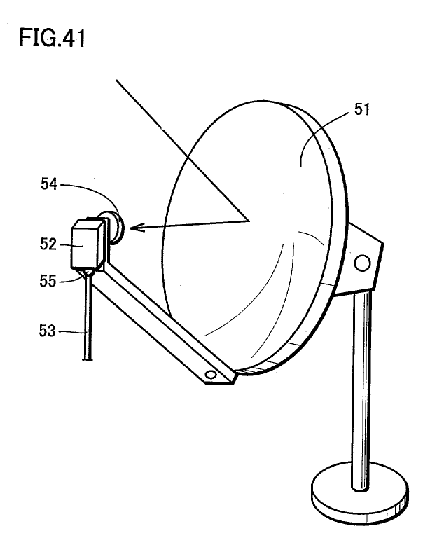

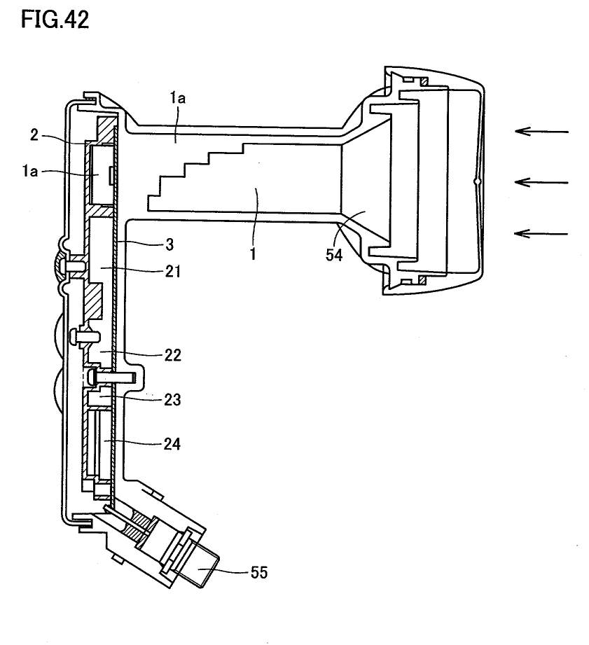

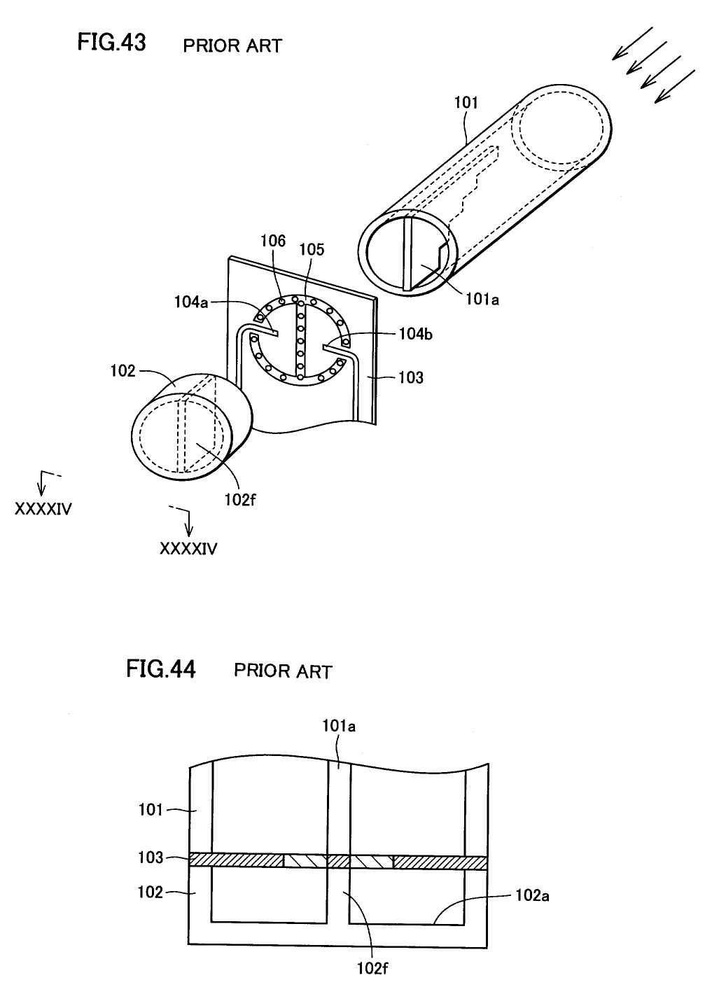

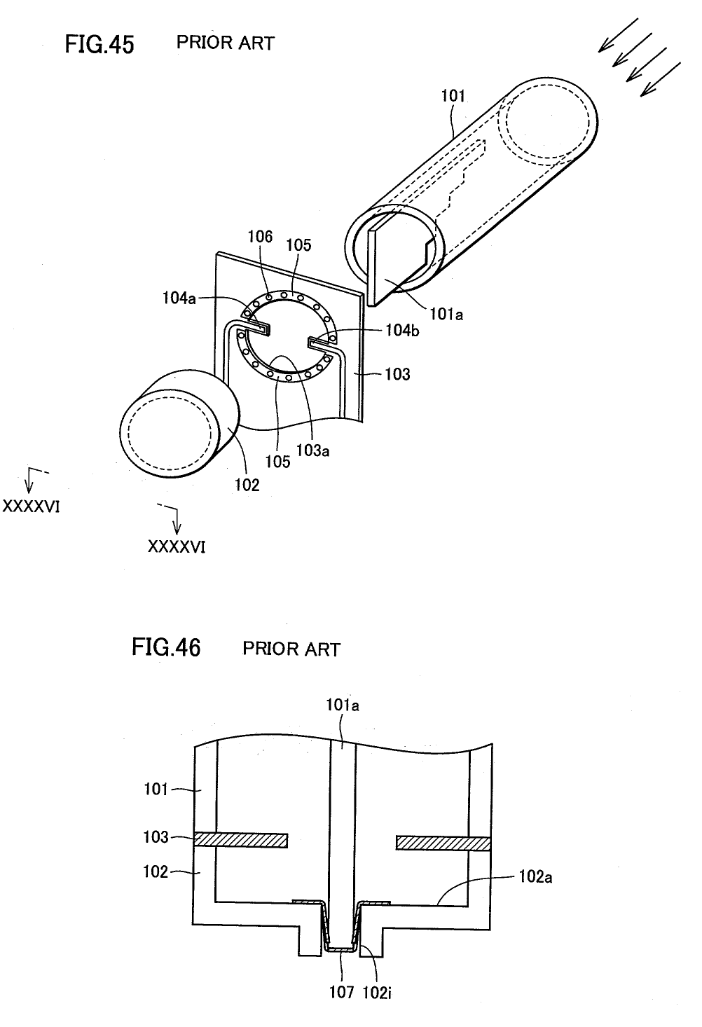

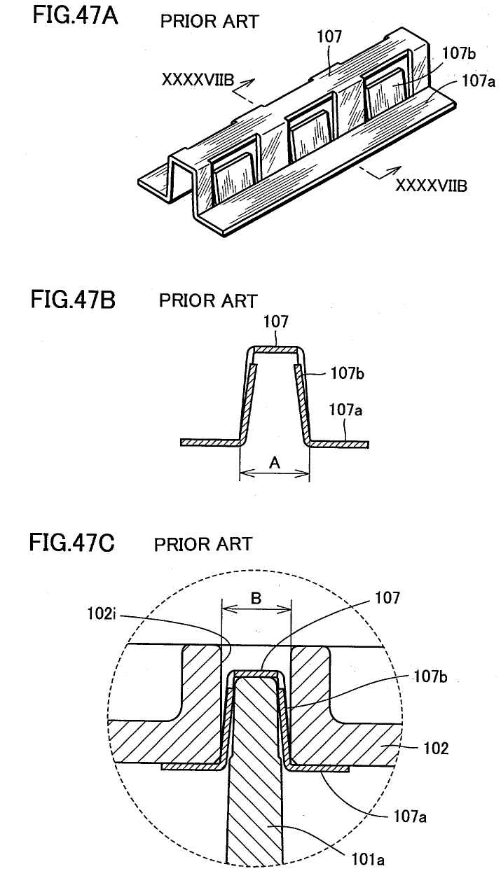

FIG. 41 is a perspective view showing an appearance of a parabola antenna provided with a satellite broadcast receiving converter on which the polarized wave separator of the present invention is mounted. FIG. 42 is a cross section of the satellite broadcast receiving converter mounting the polarized wave separator of the present invention.

The radio wave transmitted from a satellite is reflected by reflective parabola portion 51 shown in FIG. 41, collected and transmitted to a feed horn 54, and further transmitted to radio wave receiving converter 52. The radio wave that has been transmitted to radio wave receiving converter 52 is amplified with low noise by an internal circuitry, converted to an intermediate frequency signal, and transmitted from an output terminal 55 through a co-axial cable 56 to a BS receiver, not shown.

The structure of the satellite broadcast receiving converter mounting the polarized wave separator shown in FIG. 42 will be described. In a succeeding stage of feed horn 54, the polarized wave separator of the present invention formed by wave guide 1, substrate 3 and radio wave reflecting portion 2 is mounted. Thus, the circularly polarized wave (radio wave) collected by feed horn 54 is transmitted to waveguide 1, and by the polarized wave separator, separated into d-polarized wave and l-polarized wave. The d-polarized wave as the polarized wave to be received is subjected to low noise amplification by an LAN (low noise amplifier) 21 arranged on substrate 3, combined with a local signal that is oscillated by a local oscillator portion 22 and converted to an intermediate frequency (IF), further amplified by an IF amplifier 24, and transmitted through an output terminal to the BS receiver.

The l-polarized wave is attenuated by the reflection free terminating portion of the polarized wave separator, and therefore, it is hardly output. Namely, only the d-polarized wave as the wave to be received can be received with high purity.

As described above, according to the embodiments of the present invention, a polarized wave separating structure, a radio wave receiving converter and an antenna apparatus that can provide fully satisfactory polarized wave separating characteristic without leakage of the radio wave to the outside or increased noise, that have simple structure and improve the ratio of satisfactory products of mass production and that are low cost and superior for mass production can be obtained.

Further, when only one of the two components included in the microwave is to be received, the received polarized wave can be separated with high efficiency and the unnecessary polarized wave can sufficiently be attenuated by the reflection free terminating portion, by using the polarized wave separating structure of the present invention. Therefore, unnecessary polarized wave is not received, and satisfactory state of reception is attained.

Further, the present invention has a simple structure, is superior for mass production, and cost advantageous, as the structure can be reduced in size and inexpensive material can be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A polarized wave separating mechanism for separating polarized wave signals from first and second polarized wave components, comprising:
a substrate portion having an opening and provided with a pair of radio wave receiving portions;
a waveguide arranged on a side of one surface of said substrate portion, and provided with a septum portion therein; and
a radio wave reflecting portion arranged on the side of the other surface of said substrate portion and provided with a radio wave reflecting surface on an inner side; wherein
said septum portion is extended through said opening to said radio wave reflecting portion so as to separate respective polarized waves received by said pair of radio wave receiving portions; and
a space between said septum portion and said radio wave reflecting portion is set such that an end surface of said wave guide on the side of said substrate is in contact with a grounding surface provided on one surface of said substrate portion, and an end surface of said radio wave reflecting portion on the side of said substrate portion is in contact with a grounding surface provided on the other surface of said substrate portion.

2. The polarized wave separating structure according to claim 1, wherein
said space is set such that said septum portion is not in contact with said radio wave reflecting portion.

3. A polarized wave separating structure according to claim 1, wherein
said septum portion is provided not in contact with an inner surface of said opening.

4. A polarized wave separating structure according to claim 1, wherein
a slot to which a part of said septum portion is inserted is provided on an inner peripheral surface of said radio wave receiving portion.

5. A polarized wave separating structure according to claim 4, wherein
said slot has such a shape that widens from the bottom to opening side.

6. The polarized wave separating structure according to claim 4, wherein
said slot is provided on an inner surface of a cylindrical portion of said radio wave reflecting portion or on an end surface of said septum portion opposing to the cylindrical portion of said radio wave reflecting portion, and the bottom portion of said slot has such a shape that widens from the side .of said radio wave reflecting surface to the side of said substrate portion.

7. The polarized wave separating structure according to claim 1, wherein
a slot to which a part of said septum portion is inserted is provided on the radio wave reflecting surface of said radio wave reflecting portion.

8. The polarized wave separating structure according to claim 1, wherein
a protruded portion is provided on an inner peripheral surface of said radio wave reflecting portion, and a slot to which said protruded portion is inserted is provided on said septum portion.

9. A polarized wave separating structure according to claim 8, wherein
a protruded portion is provided on a reflecting surface of said radio wave reflecting portion, and a slot to which said protruded portion is inserted is provided on said septum portion.

10. A polarized wave separating structure for separating polarized wave signals from first and second radio wave components, respectively, comprising:
a substrate portion having an opening and provided with a pair of radio wave receiving portions;
a wave guide arranged on one side of said substrate portion; and
a radio wave reflecting portion arranged on the other side of said substrate portion, provided with a radio wave reflecting surface on an inner side and a septum portion therein; wherein
said septum portion is extended through said opening to said waveguide, for separating respective polarized waves received by said pair of radio wave receiving portions; and
a space between said septum portion and said waveguide is set such that an end surface of said waveguide on the side of said substrate portion is in contact with a grounding surface provided on one surface of said substrate portion, and an end surface of said radio wave receiving portion on the side of said substrate portion is in contact with a grounding surface provided on the other surface of said substrate portion.

11. A polarized wave separating structure according to claim 10, wherein
said space is set such that said septum portion and said waveguide are not in contact with each other.

12. The polarized wave separating structure according to claim 10, wherein
said septum portion is provided not to be in contact with an inner surface of said opening.

13. The polarized wave separating structure according to claim 10, wherein
a slot to which a part of said septum portion is inserted is provided on an inner peripheral surface of said waveguide.

14. The polarized wave separating structure according to claim 13, wherein
said slot is formed to have such a shape that widens from the bottom to opening side.

15. The polarized wave separating structure according to claim 13, wherein
the bottom portion of said slot is formed to have such a shape that widens from radio wave entrance side of said waveguide to the side of said substrate portion.

16. The polarized wave separating structure according to claim 10, wherein
a protruded portion is provided on an inner peripheral surface of said waveguide, and a slot to which said protruded portion is inserted is provided on said septum portion.

17. A polarized wave separating structure, comprising:
a substrate portion having an opening and provided with a pair of radio wave receiving portions;
a waveguide arranged on one side of said substrate portion and provided with a septum portion therein; and
a radio wave reflecting portion arranged on the other side of said substrate portion, and provided with a radio wave reflecting surface on an inner side and a septum portion therein; wherein
said septum portions are arranged opposite to each other to separate respective polarized waves received by said pair of radio wave receiving portions; and
a space between said septum portions is set such that an end surface of said waveguide on the side of said substrate portion is in contact with a grounding surface provided on one surface of said substrate portion, and an end surface of said radio wave reflecting portion on the side of said substrate portion is in contact with a grounding surface provided on the other surface of said substrate portion.

18. The polarized wave separating structure according to claim 17, wherein
said space is set such that the septum portion of said waveguide is not in contact with the septum portion of said radio wave reflecting portion.

19. The polarized wave separating structure according to claim 17, wherein
both the septum portion of said waveguide and the septum portion of said radio wave reflecting portion are arranged not in contact with an inner surface of said opening.

20. The polarized wave separating structure according to claim 19, wherein
both the septum portion of said waveguide and the septum portion of said radio wave reflecting portion are arranged not to penetrate through said opening.

21. The polarized wave separating structure according to claim 17, wherein
a protruded portion is provided on one of opposing end surfaces of the septum portions of said waveguide and said radio wave reflecting portion, and a slot to which said protruded portion is inserted is provided on the other.

22. The polarized wave separating structure according to claim 21, wherein
said slot is formed to have such a shape that widens from the bottom to the opening side.

23. The polarized wave separating structure according to claim 17, wherein
a reflection free terminating portion absorbing received polarized wave is provided on either one of the pair of radio wave receiving portions provided on said substrate.

24. The polarized wave separating structure according to claim 17, wherein
said reflection free terminating portion is grounded through a terminating resistor.

25. The polarized wave separating structure according to claim 24, wherein
said reflection free terminating portion includes a receiving probe to which said terminal resistor is connected, and
a stub matching portion formed between said receiving probe and said terminating resistor.

26. A polarized wave separating structure for separating respective polarized wave signals from first and second polarized wave components, respectively, comprising:
a substrate portion having an opening and provided with one radio wave receiving portion;
a waveguide arranged on a side of one surface of said substrate portion and provided with a septum portion therein; and
a radio wave reflecting portion arranged on a side of the other surface of said substrate portion and having a radio wave receiving surface formed on an inner side; wherein
said waveguide, said substrate portion and said radio wave receiving portion form a waveguide space;
said septum portion extends through said opening to said radio wave reflecting portion to divide said radio wave reflecting surface into two;
said septum portion parts said waveguide space into a waveguide space in which said one radio wave receiving portion is positioned and the other waveguide space; and
a reflection free terminating portion is formed in said the other waveguide space.

27. The polarized wave separating structure according to claim 26, wherein
one part of said waveguide separated by said septum on an end portion on the side of said substrate portion is closed forming at an inner surface a reflecting surface, and the other part separated by said septum is opened to transmit the polarized wave to a succeeding stage;
said opening of said substrate portion has such a shape that corresponds to the opening of said waveguide; and
said radio wave reflecting portion is formed to have the same shape as the opening of said waveguide.

28. The polarized wave separating structure according to claim 26, wherein
one part of said waveguide separated by said septum at an end portion on the side of said substrate portion is closed forming at an inner surface a reflecting surface, and the other part separated by said septum is opened to transmit the polarized wave to a succeeding stage;
the septum of said waveguide extends passing through said opening of the substrate to the radio wave reflecting portion of the succeeding stage; and
the opening of said substrate portion and the opening of said radio wave reflecting portion of the succeeding stage have such shapes that correspond to the shape of the opening of said waveguide and the cross sectional shape of the septum of said waveguide.

29. The polarized wave separating structure according to claim 27, wherein
said reflection free terminating portion is formed on a reflecting surface provided by closing one of the parts of said waveguide separated by the septum.

30. The polarized wave separating structure according to claim 29, wherein
the reflection free terminating portion formed on said reflecting surface is a plate shaped radio wave absorber.

31. The polarized wave separating structure according to claim 29, wherein
the reflection free terminating portion formed at said reflecting surface is a semi-columner radio wave absorber.

32. The polarized wave separating structure according to claim 29, wherein
the reflection free terminating portion formed at said reflecting surface is a semi-conical radio wave absorber.

33. The polarized wave separating structure according to claim 29, wherein
the radio wave absorber at said reflection free terminating portion is a resistance plate.

34. A polarized wave separating structure according to claim 33, wherein
said resistance plate has one end on the side of the waveguide on the side of said opening provided with a cutout.

35. A radio wave receiving converter having a polarized wave separating structure for separating respective polarized wave signals from first and second polarized wave components, wherein said polarized wave separating structure includes
a substrate portion having an opening and provided with a pair of radio wave receiving portions;
a waveguide arranged on a side of one surface of said substrate portion, and provided with a septum portion therein; and
a radio wave reflecting portion arranged on the side of the other surface of said substrate portion and provided with a radio wave reflecting surface on an inner side; wherein
said septum portion is extended through said opening to said radio wave reflecting portion so as to separate respective polarized waves received by said pair of radio wave receiving portions; and
a space between said septum portion and said radio wave reflecting portion is set such that an end surface of said wave guide on the side of said substrate is in contact with a grounding surface provided on one surface of said substrate portion, and an end surface of said radio wave reflecting portion on the side of said substrate portion is in contact with a grounding surface provided on the other surface of said substrate portion.

36. An antenna apparatus according to claim 35, further comprising
a reflecting parabola portion reflecting and guiding the received radio wave to said radio wave receiving converter.
